(19) United States
(12) Patent Application Publication
(10) Pub. No.: US 2025/0339767 A1
(43) Pub. Date: Nov. 6, 2025

(54) CLOUD GAMING PROCESSING

(71) Applicant: Tencent Technology (Shenzhen) Company Limited, Shenzhen (CN)

(72) Inventors: Jianhui ZHANG, Shenzhen (CN); Jinmei DENG, Shenzhen (CN)

(73) Assignee: Tencent Technology (Shenzhen) Company Limited, Shenzhen, GD (CN)

(21) Appl. No.: 19/267,410

(22) Filed: Jul. 11, 2025

Related U.S. Application Data
(63) Continuation of application No. PCT/CN2024/082407, filed on Mar. 19, 2024.

(30) Foreign Application Priority Data
May 18, 2023 (CN) 202310562560.5

(51) Int. Cl. A63F 13/355

(52) U.S. Cl. CPC A63F 13/355

(57) ABSTRACT

In a cloud gaming processing method, a virtual machine sharing interface of a virtual machine installed on a first terminal is displayed based on a resource sharing triggering operation. The virtual machine is configured to access at least part of a computing power resource in the first terminal. Access information of the virtual machine is transmitted to a cloud gaming platform based on a virtual machine sharing operation. The virtual machine sharing operation is performed via the virtual machine sharing interface. The cloud gaming platform schedules access to the computing power resource via the virtual machine of the first terminal based on the access information. Apparatus and non-transitory computer-readable storage medium counterpart aspects are also contemplated.

### RELATED APPLICATIONS

The present application is a continuation of International Application No. PCT/CN2024/082407, filed on Mar. 19, 2024, which claims priority to Chinese Patent Application No. 202310562560.5, filed on May 18, 2023. The entire disclosures of the prior applications are hereby incorporated by reference.

### FIELD OF THE TECHNOLOGY

This disclosure relates to the field of cloud gaming technologies, including to a cloud gaming interaction method and apparatus, a computer device, and a storage medium.

### BACKGROUND OF THE DISCLOSURE

With the development of cloud technologies, a cloud gaming technology emerges. Cloud gaming refers to, for example, that a game is run on a server, the server transmits a rendered game picture to a client, and the client displays the game picture. In a case that the client of cloud gaming is installed on a terminal, a game interface may be displayed while a game does not need to be downloaded.

In the related art, a server of a cloud gaming platform serves as a server running the game in a cloud gaming scenario, and the server of the cloud gaming platform returns the rendered game interface to a client of the cloud gaming platform.

However, computing power resources in the server of the cloud gaming platform are limited. When excessive games are run on the cloud gaming platform, the server of the cloud gaming platform may fail to respond to a game start request initiated by the client due to insufficient computing power resources, whereby the client needs to wait and the cloud gaming interaction efficiency is low.

### SUMMARY

Based on this, in view of the above technical problems, it is necessary to provide a cloud gaming interaction method and apparatus, a computer device, a computer-readable storage medium, and a computer program product to improve the cloud gaming interaction efficiency.

In an aspect of this disclosure, a cloud gaming processing method is provided. In the method, a virtual machine sharing interface of a virtual machine installed on a first terminal is displayed based on a resource sharing triggering operation. The virtual machine is configured to access at least part of a computing power resource in the first terminal. Access information of the virtual machine is transmitted to a cloud gaming platform based on a virtual machine sharing operation. The virtual machine sharing operation is performed via the virtual machine sharing interface. The cloud gaming platform schedules access to the computing power resource via the virtual machine of the first terminal based on the access information.

In an aspect of this disclosure, a cloud gaming processing method is provided. In the method, a target shared virtual machine is determined from a plurality of shared virtual machines of a cloud gaming platform based on a start request of a second terminal for a target game. The target shared virtual machine is in a shared state and configured to access at least a part of a computing power resource of a first terminal of a plurality of terminals. The plurality of shared virtual machines are provided by the plurality of terminals. Establishment of a communication connection between the target shared virtual machine of the first terminal and the second terminal is triggered based on access information of the target shared virtual machine. An operation instruction for the target game is transmitted by the second terminal to the target shared virtual machine via the communication connection. Game content is rendered by the target shared virtual machine according to the operation instruction and transmitted to the second terminal.

In an aspect of this disclosure, a cloud gaming processing system is provided. The cloud gaming processing system includes a first terminal including processing circuitry that is configured to display a virtual machine sharing interface of a virtual machine installed on the first terminal based on a resource sharing triggering operation. The virtual machine is configured to access at least part of a computing power resource in the first terminal. The processing circuitry is configured to transmit access information of the virtual machine to a cloud gaming platform based on a virtual machine sharing operation. The virtual machine sharing operation is performed via the virtual machine sharing interface. The cloud gaming platform schedules access to the computing power resource via the virtual machine of the first terminal based on the access information.

According to an aspect, a cloud gaming interaction method, performed by a first terminal, includes: displaying a virtual machine sharing interface for a virtual machine installed on the first terminal in response to a resource sharing triggering operation initiated at the first terminal, the installed virtual machine occupying at least part of a computing power resource in the first terminal; and transmitting access information of the virtual machine to a cloud gaming platform in response to a virtual machine sharing operation triggered based on the virtual machine sharing interface, to cause the cloud gaming platform to obtain a permission for scheduling the computing power resource, occupied by the virtual machine, of the first terminal according to the access information, the access information being configured for accessing the virtual machine.

In another aspect, this disclosure further provides a cloud gaming interaction apparatus. The apparatus includes: an interface display module, configured to display a virtual machine sharing interface for a virtual machine installed on a first terminal in response to a resource sharing triggering operation initiated at the first terminal, the installed virtual machine occupying at least part of a computing power resource in the first terminal; and an information transmitting module, configured to transmit access information of the virtual machine to a cloud gaming platform in response to a virtual machine sharing operation triggered based on the virtual machine sharing interface, to cause the cloud gaming platform to obtain a permission for scheduling the computing power resource, occupied by the virtual machine, of the first terminal according to the access information.

In another aspect, this disclosure provides a cloud gaming interaction method, performed by a second terminal, and including: displaying a cloud gaming platform interface, the cloud gaming platform interface including at least one game entry; obtaining a game interface of a target game transmitted by a shared virtual machine in response to a triggering operation for a game entry of the target game, the game interface being rendered by a computing power resource provided by the shared virtual machine on a cloud gaming platform, and the computing power resource provided by the shared virtual machine being at least part of a computing power resource of a terminal on which the shared virtual machine is installed; and displaying the game interface.

In another aspect, this disclosure further provides a cloud gaming interaction apparatus. The apparatus includes: a platform interface display module, configured to display a cloud gaming platform interface, the cloud gaming platform interface including at least one game entry; a game interface obtaining module, configured to obtain a game interface of a target game transmitted by a shared virtual machine in response to a triggering operation for a game entry of the target game, the game interface being rendered by a computing power resource provided by the shared virtual machine on a cloud gaming platform, and the computing power resource provided by the shared virtual machine being at least part of a computing power resource of a terminal on which the shared virtual machine is installed; and a game interface display module, configured to display the game interface.

In another aspect, this disclosure provides a cloud gaming interaction method, performed by a server, and including: determining a target shared virtual machine from shared virtual machines of a cloud gaming platform in response to a start request of a second terminal for a target game, the cloud gaming platform having a permission for scheduling at least part of a computing power resource of a terminal on which the shared virtual machine is installed, and the target shared virtual machine being currently in a shared state and having the target game installed thereon; and triggering establishment of a communication connection between the target shared virtual machine and the second terminal based on access information of the target shared virtual machine, the access information of the target shared virtual machine being configured for accessing the target shared virtual machine, and the communication connection being configured for transmitting an operation instruction triggered by the second terminal for the target game to the target shared virtual machine, and transmitting a game interface rendered by the target shared virtual machine according to the operation instruction to the second terminal.

In another aspect, this disclosure provides a cloud gaming interaction apparatus. The apparatus includes: a request response module, configured to determine a target shared virtual machine from shared virtual machines of a cloud gaming platform in response to a start request of a second terminal for a target game, the cloud gaming platform having a permission for scheduling at least part of a computing power resource of a terminal on which the shared virtual machine is installed, and the target shared virtual machine being currently in a shared state and having the target game installed thereon; and a connection establishment triggering module, configured to trigger establishment of a communication connection between the target shared virtual machine and the second terminal based on access information of the target shared virtual machine, the communication connection being configured for transmitting an operation instruction triggered by the second terminal for the target game to the target shared virtual machine, and transmitting a game interface rendered by the target shared virtual machine according to the operation instruction to the second terminal.

In another aspect, this disclosure further provides a computer device. The computer device includes a memory and a processor, the memory having a computer program stored therein, and the processor executing the computer program to implement the operations of the foregoing cloud gaming interaction method.

In another aspect, this disclosure further provides a non-transitory computer-readable storage medium. The computer-readable storage medium stores instructions which, when executed by a processor, cause the processor to implement the operations of the foregoing cloud gaming interaction method.

In another aspect, this disclosure further provides a computer program product. The computer program product includes a computer program, and the computer program, when executed by a processor, implements the operations of the foregoing cloud gaming interaction method.

Details of one or more aspects of this disclosure are provided in the accompanying drawings and descriptions below. Other features, objectives, and advantages of this disclosure become apparent from the description, the drawings, and the claims.

### BRIEF DESCRIPTION OF THE DRAWINGS

To describe the technical solutions in aspects of this disclosure, the following briefly describes the accompanying drawings required in the description of the aspects. The accompanying drawings in the following descriptions show merely some aspects of this disclosure, and a person of ordinary skill in the art may still derive other drawings from these accompanying drawings.

FIG. 1 is a diagram of an disclosure environment of a cloud gaming interaction method according to some aspects.

FIG. 2 is a schematic flowchart of a cloud gaming interaction method according to some aspects.

FIG. 3 is a schematic diagram of a virtual machine sharing interface according to some aspects.

FIG. 4 is a schematic diagram of a first option and a second option according to some aspects.

FIG. 5 is a schematic diagram of corresponding display of an identifier of a virtual machine and a shared state control according to some aspects.

FIG. 6 is a schematic diagram of a login information setting interface according to some aspects.

FIG. 7 is a schematic diagram of display of evaluation progress prompt information according to some aspects.

FIG. 8 is a schematic diagram of a virtual machine installation interface according to some aspects.

FIG. 9 is a schematic diagram of a download guidance interface according to some aspects.

FIG. 10 is a schematic diagram of a sharing solicitation interface according to some aspects.

FIG. 11 is a schematic diagram of an interface of a virtual machine according to some aspects.

FIG. 12 is a schematic diagram of an interface of a virtual machine according to some aspects.

FIG. 13 is a schematic flowchart of a cloud gaming interaction method according to some aspects.

FIG. 14 is a schematic flowchart of a cloud gaming interaction method according to some aspects.

FIG. 15A is a schematic flowchart of a cloud gaming interaction method according to some aspects.

FIG. 15B is an interaction sequence diagram of a first terminal, a second terminal, and a server according to some aspects.

FIG. 16 is a schematic flowchart of a cloud gaming interaction method according to some aspects.

FIG. 17 is a schematic flowchart of a cloud gaming interaction method according to some aspects.

FIG. 18 is a structural block diagram of a cloud gaming interaction apparatus according to some aspects.

FIG. 19 is a structural block diagram of a cloud gaming interaction apparatus according to some aspects.

FIG. 20 is a structural block diagram of a cloud gaming interaction apparatus according to some aspects.

FIG. 21 is a diagram of an internal structure of a computer device according to some aspects.

FIG. 22 is a diagram of an internal structure of a computer device according to some aspects.

### DETAILED DESCRIPTION

Technical solutions in aspects of this disclosure are described in the following with reference to the accompanying drawings. The described aspects are merely some rather than all of the aspects of this disclosure. All other aspects obtained by a person of ordinary skill in the art based on the aspects of this disclosure fall within the scope of protection of this disclosure. Examples of terms involved in the aspects of the disclosure are briefly introduced. The descriptions of the terms are provided as examples only and are not intended to limit the scope of the disclosure.

A cloud gaming interaction method provided in the aspects of this disclosure may be applied to an application environment shown in FIG. 1. The application environment includes a first terminal 102, a server 104, and a second terminal 106. The first terminal 102, the server 104, and the second terminal 106 communicate over a network. A data storage system may store data that needs to be processed by the server 104. The data storage system may be integrated onto the server 104, or arranged on cloud or another server. The first terminal 102 has a function of rendering a game picture, and the first terminal 102 includes a video card configured to implement game rendering. The video card (further referred to as a display card, a graphics card, or a video adapter) is one of basic components of a personal computer, converts display information required by a computer system to drive a display, and provides a progressive or interlaced scanning signal to the display, to control correct display of the display. It is an important component connecting the display to a main-board of the personal computer, and is one of important “human-computer” interaction devices. A built-in parallel computing capability of the video card is further configured for operations such as deep learning at the present stage. The server 104 provides a cloud gaming service. Cloud gaming may alternatively be referred to as gaming on demand, and is an online gaming technology based on a cloud computing technology. The cloud gaming technology enables a thin client with limited graphics processing and data computing capabilities to run a high-quality game. The second terminal 106 is a player game terminal. The server is a server on which a cloud gaming platform is located, and the server provides the cloud gaming service. In a cloud gaming scenario, a game runs on a cloud server rather than on the second terminal 106, and the cloud server renders the gaming scenario into video and audio streams, and transmits the video and audio streams to the second terminal 106 over the network. The second terminal 106 does not need to have powerful graphics computing and data processing capabilities, but only needs to have a basic streaming-media playback capability and a capability to obtain instructions inputted by a player and transmit the instructions to the cloud server. To be specific, the cloud gaming adopts a gaming mode in which the server renders a game picture and a client displays the game picture.

Specifically, a virtual machine may be installed on the first terminal 102, and the first terminal 102 may store access information of the installed virtual machine into the server 104. The access information of the virtual machine is configured for accessing the virtual machine, and the access information of the virtual machine includes, but is not limited to, at least one of a network address and login information of the virtual machine. The server 104 may schedule the virtual machine on the first terminal 102 to accomplish a game rendering task based on the access information of the virtual machine. The second terminal 106 is the player game terminal. A cloud gaming client may be installed on the second terminal 106. The second terminal 106 may communicate with the server 104 through the cloud gaming client. The second terminal 106 may display an interface of the cloud gaming client, and display at least one game entry on the interface of the cloud gaming client. In response to a triggering operation for any game entry, the second terminal 106 transmits a start request for starting a corresponding game to the server 104. The server 104 schedules the virtual machine on the first terminal 102 as a server of the second terminal 106 in response to the start request, whereby the second terminal 106 may render the game interface for the first terminal 102 to achieve the cloud gaming mode. The virtual machine refers to a complete computer system that is simulated by software, has a complete hardware system function, and runs in a completely isolated environment. All operations executable on a physical computer are implementable on the virtual machine. When the virtual machine is created on a computer, part of the hard disks and part of memory capacity of the physical computer need to serve as the hard disk and memory capacity of the virtual machine. Each virtual machine has an independent complementary metal oxide semiconductor (CMOS), a hard disk, and an operating system, and the virtual machine may be operated like the physical computer. In the cloud gaming interaction method provided in this disclosure, a computing power resource other than the computing power resource provided by the cloud gaming platform, such as a computing power resource and a storage resource that are provided by the virtual machine on the first terminal 102, may be used to indirectly expand the computing power resource of the cloud gaming platform, whereby a situation that the game cannot be normally played due to the limited computing power of the cloud gaming platform can be reduced, the cloud gaming response efficiency can be improved, and the cloud gaming interaction efficiency can be improved.

The first terminal 102 and the second terminal 106 may include, but are not limited to, various desktop computers, notebook computers, smart-phones, tablet computers, Internet of Things devices, and portable wearable devices. The Internet of Things device may be a smart speaker, a smart television, a smart air conditioner, a smart onboard device, or the like. The portable wearable device may be a smart watch, a smart band, a head-mounted device, and the like. The server 104 may be an independent physical server, a server cluster or distributed system including a plurality of physical servers, or a cloud server providing basic cloud computing services such as cloud services, cloud databases, cloud computation, cloud functions, cloud storage, network services, cloud communication, middle-ware services, domain name service, security services, content delivery networks (CDNs), and big data and artificial intelligence platforms. The terminal may be a smart-phone, a tablet computer, a notebook computer, a desktop computer, a smart speaker, a smart watch, and the like, but is not limited thereto. The terminal and the server may be directly or indirectly connected by using a wired or wireless communication protocol. This is not limited in this disclosure.

Data involved in the cloud gaming interaction method provided in this disclosure may be stored in a block-chain system. For example, the access information of the virtual machine may be stored in a block-chain. The block-chain is a new application mode of a computer technology such as distributed data storage, peer-to-peer transmission, a consensus mechanism, and an encryption algorithm. The block-chain is essentially a decentralized database, and includes a series of data blocks generated associatively through a cryptographic method. Each data block includes information about a batch of network transactions, and is configured to validate the validity of the information (anti-counterfeiting) and generate a next block. The block-chain may include a block-chain bottom platform, a platform product service layer, and an application service layer. The block-chain bottom platform may include processing modules such as a user management module, a basic service module, and a smart contract module. The user management module is responsible for identity information management of all block-chain participants, including maintenance of public/private key generation (account management), key management, maintenance of a correspondence between a real user identity and a block-chain address (authority management), and the like. In addition, when authorized, the user management module monitors and audits transactions of some real identities, and provides risk control rule configuration (risk control audit). The basic service module is deployed on all block-chain node devices to validate the validity of a service request and record the effective request in a memory after a consensus is reached on the service request. For a new service request, the basic service module first performs interface adaptation, analysis, and authentication (interface adaptation), and then encrypts service information through a consensus algorithm (consensus management), transmits the encrypted service information to a shared ledger (network communication) in a complete and consistent manner after encryption, and records and stores the encrypted service information. The smart contract module is responsible for registration, issuance, triggering, and execution of a contract. A developer may define a contract logic through a specific programming language, issue the contract logic onto the block-chain (contract registration), call a key or another event to trigger execution based on a logic of contract terms, complete the contract logic, and provide functions of contract upgrading and canceling. The platform product service layer provides basic capabilities and implementation frameworks for typical applications. The developer may superimpose characteristics of the service based on the basic capabilities, to achieve the block-chain service logic. The application service layer provides application services based on block-chain solutions for service participants to use. Storing the data into the block-chain system may avoid tampering of the data, and improve the security of the data. For example, storing the access information of the virtual machine into the block-chain system may ensure the security of the access information of the virtual machine.

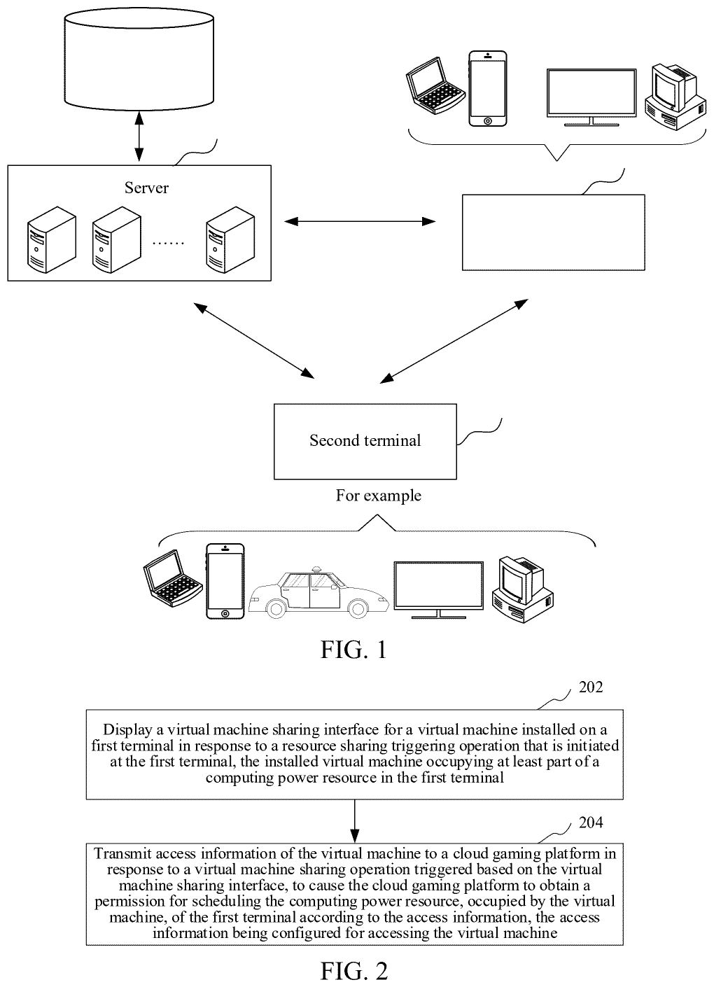

In some aspects, as shown in FIG. 2, a cloud gaming interaction method is provided. The method may be performed by a terminal or a server, or may be performed jointly by the terminal and the server. A description is made by using an example in which the method is applied to the first terminal 102 in FIG. 1. The method includes the following operations:

Operation 202: Display a virtual machine sharing interface for a virtual machine installed on the first terminal in response to a resource sharing triggering operation initiated at the first terminal, the installed virtual machine occupying at least part of a computing power resource in the first terminal. In an example, a virtual machine sharing interface of a virtual machine installed on a first terminal is displayed based on a resource sharing triggering operation. The virtual machine is configured to access at least part of a computing power resource in the first terminal.

The resource sharing triggering operation is configured for triggering the sharing of a local computing power resource with a cloud gaming platform. The computing power refers to a computing capability. The computing power resource refers to a resource providing the computing capability, including but not limited to a resource of processing circuitry, such as a central processing unit (CPU), an internal memory, a hard disk, or a graphics processing unit (GPU). The virtual machine occupies the computing power resources. This refers to that the computing power resources are allocated for the virtual machine to use, all or part of the occupied computing power resource is in a used state, and a part of the computing power resource may be in an idle state. The virtual machine occupies at least part of the computing power resource in the first terminal, where for each required type of the computing power resource, the virtual machine may occupy all or part of the computing power resource, for example, may occupy all or part of a CPU, or all or part of an internal memory.

The virtual machine sharing interface is configured to share at least one of login information and a network address of the virtual machine with the cloud gaming platform. The virtual machine sharing interface may be an interface provided by a resource sharing application.

Specifically, the resource sharing application may be installed on the first terminal. The resource sharing application is configured to provide a service of sharing a computing power resource of a terminal, such as the first terminal, with the cloud gaming platform. The resource sharing application may further be referred to as a cloud gaming helper program. The first terminal may display the interface of the resource sharing application, and display a resource sharing triggering control on the interface provided by the resource sharing application. The resource sharing triggering operation may be a triggering operation for the resource sharing triggering control. The triggering operation for the resource sharing triggering control includes, but is not limited to, an operation such as a click/tap, a double-click/tap, or a swipe.

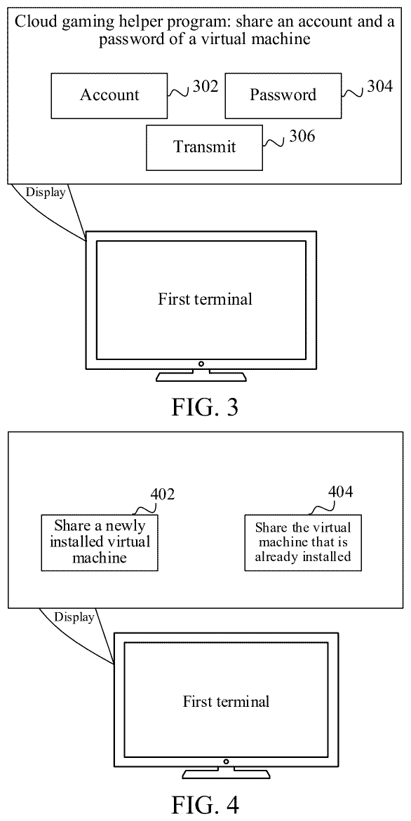

In some aspects, the first terminal displays the virtual machine sharing interface on the resource sharing application, and displays a login information input area on the virtual machine sharing interface. The login information input area is configured to input login information of the virtual machine installed on the first terminal. In a case that the login information includes an account and a password, the login information input area may include an account input area and a password input area. FIG. 3 is a schematic diagram of a virtual machine sharing interface. The virtual machine sharing interface in FIG. 3 displays an account input area 302 and a password input area 304.

In some aspects, the first terminal displays a first option and a second option in response to the resource sharing triggering operation that is initiated at the first terminal. Selection of the first option indicates that a new virtual machine is selected to be installed on the first terminal, and the newly installed virtual machine is shared with the cloud gaming platform. Selection of the second option indicates that the virtual machine already installed on the first terminal is selected to be shared with the cloud gaming platform. If the first terminal receives a triggering operation for the first option, the interface is switched to a virtual machine installation interface, and the virtual machine is installed on the first terminal in response to triggering for the virtual machine installation interface. If the first terminal receives a triggering operation for the second option, the interface is switched to the virtual machine sharing interface. The virtual machine sharing interface may be configured to input the login information of the virtual machine already installed on the first terminal. Therefore, the new virtual machine may be installed, and the newly installed virtual machine may be shared with the cloud gaming platform, or the virtual machine already installed on the first terminal may be shared with the cloud gaming platform. Flexibility and efficiency for sharing the virtual machine are improved. FIG. 4 is a schematic diagram of a first option and a second option. FIG. 4 shows a first option 402 and a second option 404.

Operation 204: Transmit access information of the virtual machine to a cloud gaming platform in response to a virtual machine sharing operation triggered based on the virtual machine sharing interface, to cause the cloud gaming platform to obtain a permission for scheduling the computing power resource, occupied by the virtual machine, of the first terminal according to the access information, the access information being configured for accessing the virtual machine. In an example, access information of the virtual machine is transmitted to a cloud gaming platform based on a virtual machine sharing operation. The virtual machine sharing operation is performed via the virtual machine sharing interface.

The virtual machine sharing operation is configured for triggering the sharing of the access information of the virtual machine with the cloud gaming platform. The access information of the virtual machine includes, but is not limited to, at least one of a network address of the virtual machine and the login information of the virtual machine. The cloud gaming platform is capable of supporting running of cloud gaming, and may cooperate with the terminal (at least one of the first terminal and the second terminal) to support the running of the cloud gaming. After the permission for scheduling the computing power resource, occupied by the virtual machine, of the first terminal is obtained, the permission for scheduling the computing power resource, occupied by the virtual machine, of the first terminal is possessed. In an example, the cloud gaming platform schedules access to the computing power resource via the virtual machine of the first terminal based on the access information.

Specifically, the first terminal may store a correspondence between the network address and login information of the virtual machine, whereby the network address may be retrieved according to the login information, for example, the network address may be retrieved according to an account in the login information. The first terminal obtains the login information inputted into the login information input area in response to the virtual machine sharing operation triggered based on the virtual machine sharing interface, searches for the corresponding network address locally according to the login information, for example, searches for the corresponding network address according to the account in the login information, and transmits the inputted login information and the network address corresponding to the login information to a server of the cloud gaming platform. The server of the cloud gaming platform stores the received access information of the virtual machine, and the virtual machine sharing the access information becomes a shared virtual machine of the cloud gaming platform. The server of the cloud gaming platform may log into the virtual machine on the first terminal by employing the login information of the virtual machine, and may schedule the virtual machine on the first terminal as a server for rendering a game interface on the cloud gaming platform, whereby the cloud gaming platform has the permission for scheduling the computing power resource, occupied by the virtual machine, of the first terminal. In an example, the computing power resource may be occupied by the virtual machine and be of the first terminal.

In some aspects, the virtual machine sharing interface displays a sharing confirmation control, and the sharing confirmation control is configured to trigger the virtual machine sharing operation. The first terminal obtains the access information of the virtual machine in response to a triggering operation for the sharing confirmation control, and transmits the access information of the virtual machine to the server of the cloud gaming platform. The triggering operation for the sharing confirmation control includes, but is not limited to, an operation such as a click/tap, a double-click/tap, or a swipe for the sharing confirmation control. For example, the sharing confirmation control is a control 306 in FIG. 3. The first terminal transmits the access information of the virtual machine to the server of the cloud gaming platform in response to a click/tap operation for the control 306.

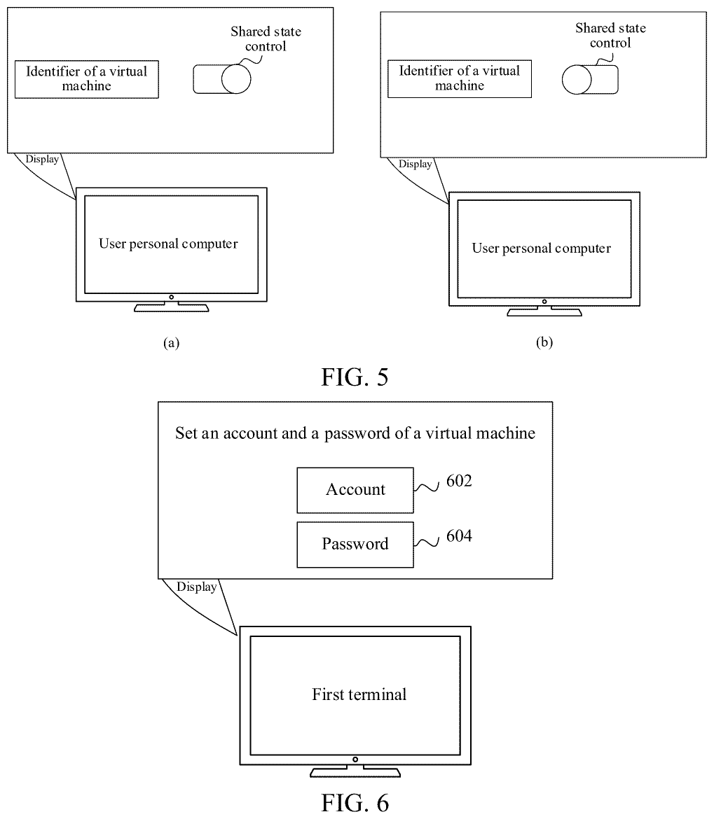

In some aspects, after the virtual machine of the first terminal becomes the shared virtual machine of the cloud gaming platform, the first terminal may display an identifier of the virtual machine, and display a shared state control corresponding to the identifier of the virtual machine. The shared state control has two states, i.e., a sharing enabled state and a sharing disabled state. If the shared state control is in a sharing enabled state, it indicates that the virtual machine is in a shared state, and if the shared state control is in a sharing disabled state, it indicates that the virtual machine is not in the shared state. The first terminal displays the shared state control that is in the sharing enabled state in response to an operation of setting the shared state control to be in the sharing enabled state. The first terminal displays the shared state control that is in the sharing disabled state in response to an operation of setting the shared state control to be in the sharing disabled state. FIG. 5 is a schematic diagram of corresponding display of an identifier of a virtual machine and a shared state control. FIG. 5(a) shows the shared state control that is in a sharing enabled state, and FIG. 5(b) shows the shared state control that is in a sharing disabled state.

In the foregoing cloud gaming interaction method, in response to the resource sharing triggering operation that is initiated at the first terminal, the virtual machine sharing interface for the virtual machine installed on the first terminal is displayed, and the installed virtual machine occupies at least part of the computing power resource of the first terminal; and in response to the virtual machine sharing operation triggered based on the virtual machine sharing interface, the access information of the virtual machine is transmitted to the cloud gaming platform, whereby the cloud gaming platform has the permission for scheduling the computing power resource, occupied by the virtual machine, of the first terminal according to the access information. Therefore, the cloud gaming is implemented by means of the computing power resource and the storage resource provided by the virtual machine. This indirectly expands the computing power resource and storage resource of the cloud gaming platform, reduces the situation that the game cannot be normally played due to limited computing power of the cloud gaming platform, improves the cloud gaming response efficiency, and improves the cloud gaming interaction efficiency.

In some aspects, the operation of displaying a virtual machine sharing interface for a virtual machine installed on the first terminal in response to a resource sharing triggering operation initiated at the first terminal includes: a virtual machine installation interface is displayed in response to the resource sharing triggering operation that is initiated at the first terminal; and the virtual machine is installed on the first terminal in response to triggering for the virtual machine installation interface.

Specifically, the virtual machine installation interface refers to an interface for installing the virtual machine. The first terminal may display an interface of a resource sharing application, and display the resource sharing triggering control on the interface provided by the resource sharing application. The first terminal displays the virtual machine installation interface in response to a triggering operation for the resource sharing triggering control.

In some aspects, the first terminal proceeds to a performance evaluation phase in response to the resource sharing triggering operation that is triggered through the resource sharing triggering control. The first terminal displays the virtual machine installation interface in a case that the performance evaluation phase is ended and a performance evaluation result indicates “pass”.

In some aspects, the first terminal may display download guidance information on the virtual machine installation interface. The download guidance information describes a virtual machine downloading manner. The download guidance information may include a virtual machine download entry. The virtual machine download entry may be, for example, a network link address for downloading the virtual machine. The first terminal downloads a virtual machine installation file in response to a triggering operation for the virtual machine download entry, and installs the virtual machine on the first terminal in response to an installation triggering operation for the virtual machine installation file. The installation triggering operation is configured for triggering the installation of the virtual machine. The virtual machine installation file is configured for installing the virtual machine.

In some aspects, in a process of installing the virtual machine, or after the virtual machine is successfully installed, the first terminal may display a login information setting interface, and the login information setting interface is configured to set login information of the installed virtual machine. The login information includes, but is not limited to, at least one of an account and a password. The first terminal may display an account setting area and a password setting area on the login information setting interface, obtain an account inputted into the account setting area and a password inputted into the password setting area in response to an operation that is triggered based on a login information setting interface and that represents completion of setting, and store the set account and password locally. FIG. 6 is a schematic diagram of a login information setting interface. The login information setting interface in FIG. 6 displays an account setting area 602 and a password setting area 604. The first terminal may obtain the network address of the installed virtual machine, and store the set account and password in correspondence with the network address, whereby the network address of the virtual machine may be retrieved according to the set account.

In the present aspect, in response to the resource sharing triggering operation that is initiated at the first terminal, the virtual machine installation interface is displayed; and in response to the triggering for the virtual machine installation interface, the virtual machine is installed on the first terminal, whereby the efficiency for installing the virtual machine is improved.

In some aspects, the operation of displaying a virtual machine installation interface in response to the resource sharing triggering operation that is initiated at the first terminal includes: a performance evaluation phase is proceeded in response to the resource sharing triggering operation that is initiated at the first terminal, the performance evaluation phase being configured for evaluating whether the first terminal satisfies a computing power resource sharing condition; and the virtual machine installation interface is displayed in a case that the performance evaluation phase is ended and a performance evaluation result indicates “pass”.

The performance evaluation refers to evaluation of a resource for providing the computing power in the first terminal, including but not limited to evaluation of a size, a model, performance, or the like of the resource such as a hard disk, a magnetic disk, or a video card. The performance evaluation phase is configured for evaluating whether the first terminal satisfies the computing power resource sharing condition. The performance evaluation result indicates “pass” or “fail”. If the performance evaluation result indicates “pass”, it indicates that the first terminal satisfies the computing power resource sharing condition. If the performance evaluation result indicates “fail”, it indicates that the first terminal fails to satisfy the computing power resource sharing condition.

Specifically, the first terminal proceeds to the performance evaluation phase in response to the resource sharing triggering operation that is initiated at the first terminal, performs the performance evaluation on the first terminal in the performance evaluation phase, and displays evaluation progress prompt information. The evaluation progress prompt information is configured for prompting a progress of the performance evaluation. The first terminal displays the virtual machine installation interface in a case that the performance evaluation phase is ended and the performance evaluation result indicates “pass”. The evaluation progress prompt information varies. For example, in the performance evaluation phase, the evaluation progress prompt information is configured for prompting that the performance evaluation is being performed, and at an end of the performance evaluation phase, the evaluation progress prompt information is configured for prompting that the performance evaluation result indicates “pass” or “fail”.

In some aspects, in a case that the performance evaluation phase is ended and the performance evaluation result indicates “fail”, the first terminal displays prompt information for prompting that the first terminal fails to satisfy the computing power resource sharing condition.

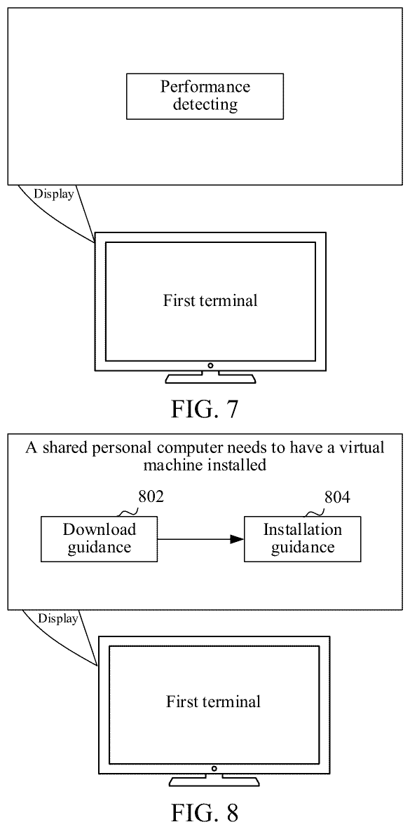

In some aspects, the first terminal may display the interface of the resource sharing application, and display the resource sharing triggering control on the interface of the resource sharing application. In response to the triggering operation for the resource sharing triggering control, the first terminal performs the performance evaluation on the first terminal by means of the resource sharing application, and displays the evaluation progress prompt information on the interface of the resource sharing application. FIG. 7 shows evaluation progress prompt information “performance detecting”. The evaluation progress prompt information may include a name of currently detected hardware.

In the present aspect, in response to the resource sharing triggering operation that is initiated at the first terminal, the first terminal proceeds to the performance evaluation phase. In a case that the performance evaluation phase is ended and the performance evaluation result indicates “pass”, the virtual machine installation interface is displayed, whereby the virtual machine installation interface is displayed in a case that the first terminal satisfies the computing power resource sharing condition, the operation of installing the virtual machine is avoided in a case that the first terminal fails to satisfy the computing power resource sharing condition; and consequently, unnecessary interaction is reduced, and the interaction efficiency is improved.

In some aspects, the method further includes: download guidance information is displayed on the virtual machine installation interface; the operation of installing the virtual machine on the first terminal in response to the triggering for the virtual machine installation interface includes: a virtual machine installation file is downloaded in response to a virtual machine download operation triggered through the download guidance information; and the virtual machine is installed on the first terminal in response to an installation triggering operation for the downloaded virtual machine installation file.

The installation triggering operation is configured for triggering the installation of the virtual machine. The virtual machine installation file is configured for installing the virtual machine. The download guidance information is configured for describing a virtual machine downloading mode, the download guidance information may include a virtual machine download entry, and the virtual machine download entry is configured for triggering download of the virtual machine. For example, the virtual machine download entry may be a network address for downloading the virtual machine.

Specifically, the first terminal may respond, on the resource sharing application, to the resource sharing triggering operation initiated at the first terminal, display the virtual machine installation interface on the resource sharing application, and display the download guidance information on the virtual machine installation interface. The download guidance information may include the virtual machine download entry. The first terminal downloads the virtual machine installation file in response to a triggering operation for the virtual machine download entry. For example, the virtual machine installation file may be downloaded to a local hard disk. In response to an operation of opening a folder in which the virtual machine installation file is stored, the first terminal displays the virtual machine installation file stored in the folder. In response to an installation triggering operation for the virtual machine installation file, the virtual machine is installed on the first terminal.

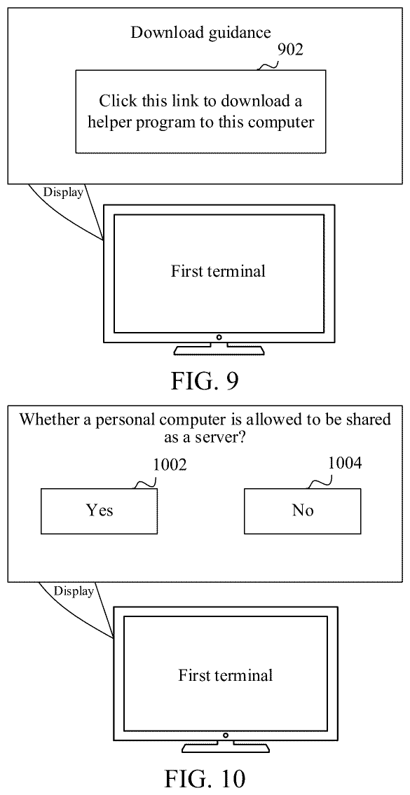

In some aspects, the first terminal may display a download guidance entry on the virtual machine installation interface, and the first terminal displays a download guidance interface in response to a triggering operation for the download guidance entry, and displays download guidance information on the download guidance interface. FIG. 8 is a schematic diagram of a virtual machine installation interface. FIG. 8 shows a download guidance entry 802. FIG. 9 shows a download guidance interface. The download guidance interface in FIG. 9 displays download guidance information 902. The first terminal switches an interface to the download guidance interface in FIG. 9 in response to a click/tap operation for the download guidance entry 802.

In some aspects, the first terminal may further display the installation guidance entry on the virtual machine installation interface. The first terminal displays installation description information in response to a triggering operation for the installation guidance entry. The installation description information is configured for describing a process of installing the virtual machine. The installation guidance entry may be, for example, a control 804 in FIG. 8.

In the present aspect, the download guidance information is displayed on the virtual machine installation interface, and the virtual machine is installed by means of the download guidance information, whereby the efficiency for installing the virtual machine is improved.

In some aspects, the operation of proceeding to a performance evaluation phase in response to a resource sharing triggering operation initiated at the first terminal includes: a resource sharing consent control is displayed on a sharing solicitation interface; the sharing solicitation interface is configured to solicit a consent of sharing the computing power resource of the first terminal with the cloud gaming platform; and the performance evaluation phase is proceeded in response to the resource sharing triggering operation that is triggered through the resource sharing consent control.

The resource sharing triggering control may be the resource sharing consent control, and the resource sharing triggering operation may be a triggering operation for the resource sharing consent control. The sharing solicitation interface may be provided by the resource sharing application. The triggering operation for the resource sharing consent control includes, but is not limited to, an operation such as a click/tap, a double-click/tap, or a swipe for the resource sharing consent control.

Specifically, the first terminal displays the sharing solicitation interface on the resource sharing application, displays the resource sharing consent control on the sharing solicitation interface, determines the consent of sharing the computing power resource of the first terminal with the cloud gaming platform in response to the triggering operation for the resource sharing consent control, proceeds to the performance evaluation phase and displays the evaluation progress prompt information.

In some aspects, the first terminal displays a resource sharing rejection control on the sharing solicitation interface. In response to a triggering operation for the resource sharing rejection control, the first terminal determines to reject sharing the computing power resource of the first terminal with the cloud gaming platform, closes the sharing solicitation interface, and may exit the resource sharing application. For example, FIG. 10 is a schematic diagram of a sharing solicitation interface. The sharing solicitation interface in FIG. 10 displays a resource sharing consent control 1002 and a resource sharing rejection control 1004.

In the present aspect, prior to the performance evaluation phase, performance evaluation is conditionally performed on the first terminal in a case that the user consent of sharing the computing power resource of the first terminal with the cloud gaming platform is obtained, whereby the security of the first terminal is improved; and in addition, the performance evaluation is to detect the performance of the hardware without involving privacy data of the user of the first terminal.

In some aspects, the access information includes login information of the virtual machine; the operation of transmitting access information of the virtual machine to the cloud gaming platform in response to a virtual machine sharing operation triggered based on the virtual machine sharing interface includes: inputted login information of the virtual machine is displayed on the virtual machine sharing interface of the virtual machine; and the login information of the virtual machine is transmitted to the cloud gaming platform in response to the virtual machine sharing operation triggered based on the virtual machine sharing interface.

Specifically, the access information may further include a network address of the virtual machine. The virtual machine sharing interface may further display a sharing confirmation control and a login information input area. The sharing confirmation control is configured to trigger a virtual machine sharing operation. In response to the triggering operation for the sharing confirmation control, the first terminal obtains the login information inputted in the login information input area, locally searches for the network address of the corresponding virtual machine according to the login information, and transmits the network address and login information of the virtual machine to a server of the cloud gaming platform. The triggering operation for the sharing confirmation control includes, but is not limited to, an operation such as a click/tap, a double-click/tap, or a swipe for the sharing confirmation control.

In the present aspect, the login information of the virtual machine is transmitted to the cloud gaming platform, enabling the server of the cloud gaming platform to obtain a privilege for logging into the virtual machine.

In some aspects, the method further includes: a game installation instruction transmitted by the cloud gaming platform to the virtual machine is received; the game installation instruction is configured for triggering installation of a specified game in the virtual machine; the specified game is installed in the virtual machine in response to the game installation instruction.

The specified game may be any game on the cloud gaming platform. The game installation instruction may carry a game identifier of the specified game or a download link address of the specified game. The game installation instruction is configured for triggering download and installation of at least one specified game in the virtual machine.

Specifically, after the first terminal transmits the network address of the virtual machine to the server of the cloud gaming platform, the server of the cloud gaming platform transmits the game installation instruction to the virtual machine on the first terminal. In response to the game installation instruction, the virtual machine on the first terminal downloads the specified game and installs the downloaded specified game into the virtual machine according to the game identifier or the download link address carried in the game installation instruction. In a process of installing the specified game, the first terminal may display installation progress prompt information of the specified game on the interface of the virtual machine. The installation progress prompt information is configured for prompting an installation progress of the virtual machine.

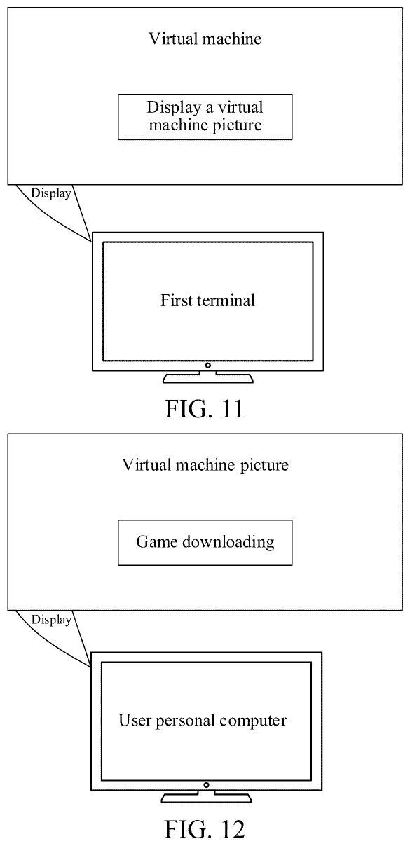

In some aspects, the first terminal displays an interface of the virtual machine in response to an operation for displaying the interface of the virtual machine. The first terminal receives the game installation instruction transmitted by the cloud gaming platform to the virtual machine. The virtual machine on the first terminal downloads and installs the specified game into the virtual machine in response to the game installation instruction, and displays information configured for prompting a game download progress or a game installation progress on the interface of the virtual machine. FIG. 11 shows an interface of a virtual machine. As shown in FIG. 12, an interface of a virtual machine displays information indicating a game download progress, specifically stating “game downloading”.

In the present aspect, the specified game is installed in the virtual machine in response to the game installation instruction transmitted by the server of the cloud gaming platform, whereby the game on the cloud gaming platform may be deployed on the virtual machine by employing the cloud gaming platform, to facilitate the scheduling of the virtual machine, and enable the virtual machine to render a game interface of the specified game.

In some embodiments, the access information includes a network address of the virtual machine; the method further includes: in a case that the virtual machine is in a logged-in state, a game rendering instruction, transmitted by a second terminal, for the specified game installed in the virtual machine is received; the game rendering instruction is transmitted by the second terminal to the first terminal based on the network address of the virtual machine, and the network address, used by the second terminal, of the virtual machine is transmitted by the cloud gaming platform to the second terminal; and the game interface of the specified game is rendered according to the game rendering instruction, and the rendered game interface is returned to the second terminal.

The second terminal is a terminal of a player in a cloud gaming mode. A cloud gaming platform interface is provided by a client of the cloud gaming platform.

Specifically, the second terminal displays the cloud gaming platform interface, and displays at least one game entry on the cloud gaming platform interface. The second terminal transmits a start request for a target game to a server of the cloud gaming platform in response to a triggering operation for the game entry of the target game. The server of the cloud gaming platform determines a target shared virtual machine from shared virtual machines of the cloud gaming platform in response to the start request. The shared virtual machine refers to a virtual machine sharing the network address with the cloud gaming platform, and login information of the shared virtual machine may further be shared with the server of the cloud gaming platform. For an example of a network address and login information sharing method, reference can be made to the foregoing method of sharing the network address and login information of the virtual machine on the first terminal with the cloud gaming platform. The cloud gaming platform may further store an identifier of the shared virtual machine. The identifier of the shared virtual machine may be transmitted to the server of the cloud gaming platform by a terminal to which the shared virtual machine belongs, or may be generated by the cloud gaming platform for the shared virtual machine. This is not limited herein. In a case that the target shared virtual machine is a virtual machine on the first terminal, the server of the cloud gaming platform may trigger establishment of a communication connection between the second terminal and the virtual machine on the first terminal. Specifically, the server of the cloud gaming platform may transmit the network address of the virtual machine on the first terminal to the second terminal, and the second terminal establishes the communication connection with the first terminal according to the network address. After the communication connection is established, the second terminal transmits a game rendering instruction for the target game to the virtual machine on the first terminal, the virtual machine on the first terminal renders a game interface of the target game according to the game rendering instruction, and returns the game interface to the second terminal, and the second terminal displays the game interface. The network address of the virtual machine used by the second terminal is transmitted by the cloud gaming platform to the second terminal in response to the start request.

In the present aspect, the first terminal, i.e., the virtual machine of the first terminal renders the game interface for the second terminal, to enable the virtual machine of the first terminal to become a server with a game interface rendering function on the cloud gaming platform. This indirectly expands the computing power resource and storage resource of the cloud gaming platform, reduces the situation that the game cannot be normally played due to limited computing power of the cloud gaming platform, improves the cloud gaming response efficiency, and improves the cloud gaming interaction efficiency.

In some aspects, after the first terminal shares the computing power resource with the second terminal, a cloud gaming account obtains an acceleration virtual resource, and the acceleration virtual resource is configured for accelerating a queuing progress of the cloud gaming account when the cloud gaming account needs to queue up to enter a game on the cloud gaming platform. The cloud gaming account is configured for logging into the cloud gaming platform at the first terminal.

The acceleration virtual resource may be in-game currency, gaming equipment, virtual items, or playtime duration in the cloud gaming account. In a case that the computing power resource on the cloud gaming platform is insufficient and no shared virtual machine can be scheduled on the cloud gaming platform, queuing needs to be performed to enter a game.

Specifically, the first terminal may display the cloud gaming platform interface, and transmit the start request for starting the game to the server in response to a triggering operation for a game entry of any game on the cloud gaming platform interface. The server transmits a queuing instruction to the first terminal in a case that it is determined that the computing power resource on the cloud gaming platform is insufficient and no shared virtual machine on the cloud gaming platform can be scheduled. The first terminal displays a queuing control of the game in response to the queuing instruction, and the first terminal displays prompt information for prompting being queuing in response to the triggering operation for the queuing control. The server may accelerate the queuing progress according to the acceleration virtual resource possessed by the cloud gaming account of the first terminal.

In some aspects, the acceleration virtual resource is awarded playtime duration that is briefly referred to as awarded duration. The server of the cloud gaming platform records sharing duration of the virtual machine of the first terminal. The sharing duration refers to a time period in which the virtual machine is configured to render the game interface for the second terminal. For example, the time period in which the second terminal utilizes the virtual machine to play a game may be used as the sharing duration. The server of the cloud gaming platform may determine the awarded duration according to the sharing duration, and determine the cloud gaming account corresponding to the virtual machine. For example, the cloud gaming account corresponding to the virtual machine may be retrieved by means of the access information of the virtual machine or the identifier of the virtual machine, and the awarded duration may be added based on the available duration of the cloud gaming account of the first terminal. The available duration refers to a time period in which a user is permitted to play games on the cloud gaming platform. The server may accelerate the queuing progress according to the available duration of the cloud gaming account of the first terminal.

In the present aspect, the cloud gaming account obtains the acceleration virtual resource, to motivate the sharing of the computing power resource.

In some aspects, the access information includes login information of the virtual machine; the method further includes: In a case that the virtual machine is in a non-logged-in state, a login request transmitted by the cloud gaming platform for the virtual machine is received; the login request carries the login information of the virtual machine; and the virtual machine is logged based on the login information, carried in the login request, of the virtual machine.

The access information of the virtual machine stored in the server of the cloud gaming platform includes the login information of the virtual machine. The access information of the virtual machine is transmitted by the first terminal to a server of the cloud gaming platform.

Specifically, in a case that the virtual machine is in the non-logged-in state, the cloud gaming platform may log into the virtual machine by means of the stored login information of the virtual machine. For example, the cloud gaming platform may transmit the login request to the virtual machine of the first terminal, where the login request carries the login information of the virtual machine; and the virtual machine of the first terminal logs into the virtual machine by employing the login information in the login request in response to the login request.

In some aspects, the login request is triggered by a start request for a target game transmitted by the second terminal and received by the cloud gaming platform. Specifically, the server of the cloud gaming platform determines the target shared virtual machine from shared virtual machines of the cloud gaming platform in response to the start request of the target game; and in a case that the target shared virtual machine is a virtual machine on the first terminal, and the virtual machine on the first terminal is in the non-logged-in state, the server of the cloud gaming platform transmits a login request to the virtual machine on the first terminal, and the virtual machine on the first terminal performs login in response to the login request by employing the login information in the login request.

In the present aspect, in a case that the virtual machine is in the non-logged-in state, the cloud gaming platform triggers the virtual machine on the first terminal to perform login by means of the login information of the virtual machine, to provide a condition for scheduling the virtual machine.

In some aspects, the operation of displaying a virtual machine installation interface in response to the resource sharing triggering operation that is initiated at the first terminal includes: an interface of a resource sharing application is displayed; the resource sharing application is configured to provide a service of sharing the computing power resource of a terminal with the cloud gaming platform; and the virtual machine installation interface is displayed on the resource sharing application in response to a resource sharing triggering operation that is triggered through the interface of the resource sharing application and that is initiated at the first terminal.

Specifically, the first terminal may display the interface of the resource sharing application, and display a resource sharing triggering control on the interface provided by the resource sharing application. The resource sharing triggering operation is configured for triggering the resource sharing triggering control. The first terminal displays the virtual machine installation interface on the resource sharing application in response to the triggering operation for the resource sharing triggering control.

In some aspects, the first terminal may display a sharing solicitation interface on the resource sharing application. The sharing solicitation interface includes a resource sharing consent control. The resource sharing triggering control may be the resource sharing consent control. The first terminal displays a virtual machine installation interface on the resource sharing application in response to a triggering operation for the resource sharing consent control. Specifically, in response to a triggering operation for the resource sharing consent control, the first terminal proceeds to a performance evaluation phase and displays evaluation progress prompt information, and displays the virtual machine installation interface in a case that the performance evaluation phase is ended and a performance evaluation result indicates “pass”.

In the present aspect, the resource sharing application, configured to provide a service of sharing the computing power resource of the terminal with the cloud gaming platform, triggers the resource sharing triggering operation and displays the virtual machine installation interface, whereby the computing power resource can be conveniently and rapidly shared with the cloud gaming platform, and consequently, the efficiency for sharing the computing power resource is improved.

In some aspects, the operation of displaying an interface of the resource sharing application includes: a login interface of the resource sharing application is displayed; a cloud gaming account inputted into the login interface is displayed; the cloud gaming account is configured for logging into the cloud gaming platform; the interface of the resource sharing application is displayed in a case that the cloud gaming account successfully logs into the resource sharing application; and the operation of transmitting access information of the virtual machine to the cloud gaming platform in response to a virtual machine sharing operation triggered based on the virtual machine sharing interface includes: in response to the virtual machine sharing operation triggered based on the virtual machine sharing interface, the access information of the virtual machine and the cloud gaming account currently logging into the resource sharing application are transmitted to the cloud gaming platform.

The account logging into the resource sharing application is the same as the account logging into the cloud gaming platform. To be specific, the accounts capable of logging into the resource sharing application are all accounts belonging to the cloud gaming platform, namely, a user of the cloud gaming platform may log into the resource sharing application. Certainly, users not belonging to the cloud gaming platform are further permitted to log into the resource sharing application. Access to the resource sharing application is not limited herein based on whether a user belongs to the cloud gaming platform.

Specifically, the first terminal displays a login interface of the resource sharing application, displays the cloud gaming account inputted into the login interface, and displays the interface of the resource sharing application, for example, displays the sharing solicitation interface provided by the resource sharing application in a case that the cloud gaming account successfully logs into the resource sharing application.

In some aspects, a manner for obtaining the resource sharing application is provided by the cloud gaming platform. Specifically, the first terminal displays the cloud gaming platform interface, and displays a download entry, on a network, of the resource sharing application on the cloud gaming platform interface. The download entry is configured to provide a function of downloading the resource sharing application. The first terminal downloads an installation file of the resource sharing application in response to a download operation triggered through the download entry. After the installation file of the resource sharing application is downloaded, the first terminal installs the resource sharing application on the first terminal in response to an installation operation for the downloaded installation file of the resource sharing application, and displays an entry, such as a desktop icon, of the resource sharing application after successful installation. The first terminal displays a login interface of the resource sharing application in response to an operation, triggered by means of the entry of the resource sharing application, for entering the resource sharing application.

In some aspects, the first terminal displays a cloud gaming account validation interface in response to a download operation triggered through the download entry. The cloud gaming account validation interface is configured to validate whether a user of the first terminal is registered with the cloud gaming platform. The first terminal responds to a validation operation triggered based on the cloud gaming account validation interface, obtains the cloud gaming account inputted into the cloud gaming account validation interface, transmits a validation request carrying the inputted cloud gaming account to the server of the cloud gaming platform, and triggers download of the installation file of the resource sharing application in a case that the validation is passed. In a case of failure in validation, the first terminal displays account registration prompt information. The account registration prompt information is configured for prompting registration of a cloud gaming account on the cloud gaming platform. The cloud gaming account refers to an account for logging into the cloud gaming platform.

In some aspects, the first terminal transmits the access information of the virtual machine and the cloud gaming account currently logging into the resource sharing application to the server of the cloud gaming platform in response to the virtual machine sharing operation triggered based on the virtual machine sharing interface. The server of the cloud gaming platform establishes a mapping relationship between the cloud gaming account and the access information of the virtual machine, and stores the mapping relationship. The server of the cloud gaming platform may further establish a mapping relationship among the cloud gaming account, the access information of the virtual machine, and the identifier of the virtual machine, whereby the corresponding cloud gaming account may be retrieved according to the identifier of the virtual machine, or the corresponding identifier of the virtual machine may be retrieved according to the cloud gaming account.

In some aspects, the server of the cloud gaming platform records a sharing duration of the virtual machine of the first terminal. The sharing duration refers to a time period in which the virtual machine is configured to render a game interface for the second terminal. For example, the time period in which the second terminal utilizes the virtual machine to play games may be used as the sharing duration. The server of the cloud gaming platform may determine an awarded duration according to the sharing duration, and determine the cloud gaming account corresponding to the virtual machine. For example, the cloud gaming account corresponding to the virtual machine may be retrieved through the access information of the virtual machine or the identifier of the virtual machine, and the awarded duration may be added based on the available duration of the cloud gaming account corresponding to the virtual machine. The available duration refers to a time period in which a user is permitted to play games on the cloud gaming platform.

In the present aspect, by logging into the resource sharing application through the cloud gaming account, and in response to the virtual machine sharing operation triggered based on the virtual machine sharing interface, the access information of the virtual machine and the cloud gaming account currently logging into the resource sharing application are transmitted to the cloud gaming platform, whereby the cloud gaming platform stores the access information of the virtual machine in correspondence with the cloud gaming account, enabling the access information of the corresponding virtual machine to be retrieved according to the cloud gaming account.

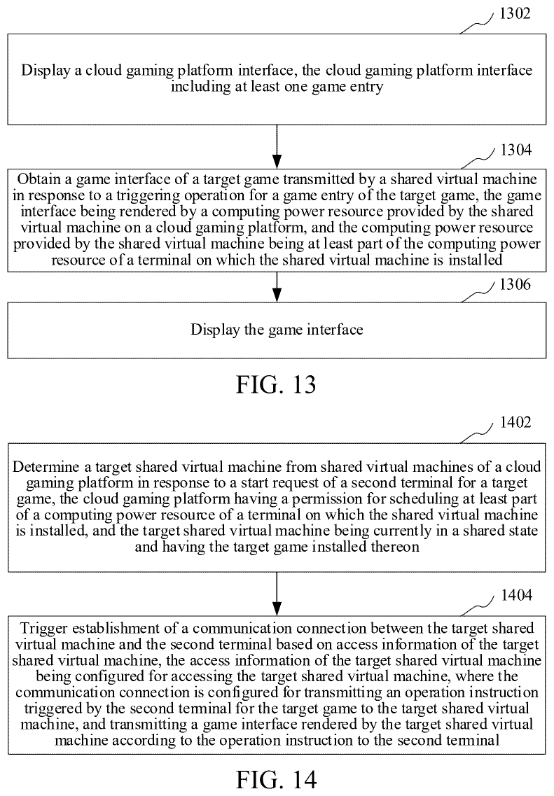

In some aspects, as shown in FIG. 13, a cloud gaming interaction method is provided. The method may be performed by a terminal or a server, or may be performed jointly by the terminal and the server. A description is made by using an example in which the method is applied to the first terminal a second terminal 106 in FIG. 1. The method includes the following operations:

Operation 1302: Display a cloud gaming platform interface, the cloud gaming platform interface including at least one game entry.

The cloud gaming platform interface is provided by a client of the cloud gaming platform. The second terminal is provided with the client of the cloud gaming platform. The game entry is an entry for entering a game.

Operation 1304: Obtain a game interface of a target game transmitted by a shared virtual machine in response to a triggering operation for the game entry of the target game, the game interface being rendered by a computing power resource provided by the shared virtual machine on the cloud gaming platform, and the computing power resource provided by the shared virtual machine being at least part of a computing power resource of a terminal on which the shared virtual machine is installed.

Operation 1306: Display the game interface.

The cloud gaming platform interface displays the game entry of the target game, and the target game may be any game on the cloud gaming platform. The triggering operation for the game entry of the target game includes, but is not limited to, an operation such as a click/tap, a double-click/tap, or a swipe for the game entry.

Specifically, the second terminal transmits a start request for the target game to a server of the cloud gaming platform in response to the triggering operation for the game entry of the target game. The server of the cloud gaming platform determines a target shared virtual machine from shared virtual machines of the cloud gaming platform, and triggers establishment of a communication connection between the target shared virtual machine and the second terminal based on a network address of the target shared virtual machine. After the connection is established, the target shared virtual machine starts the target game, renders a game interface of the target game, and transmits the rendered game interface to the second terminal. The second terminal receives the game interface returned by the target shared virtual machine and displays the game interface.

In some aspects, in response to an operation instruction triggered through the displayed game interface, the second terminal transmits the operation instruction to the target shared virtual machine. The target shared virtual machine renders the game interface triggered by the operation instruction, and returns the rendered game interface to the second terminal. The second terminal receives the game interface returned by the target shared virtual machine and displays the game interface.

In some aspects, in response to the triggering operation for the game entry of the target game, the second terminal obtains the game interface of the target game transmitted by the shared virtual machine in a case that the computing power resource of the cloud gaming platform is insufficient.

In the foregoing cloud gaming interaction method, the cloud gaming platform interface is displayed. The cloud gaming platform interface includes at least one game entry. In response to the triggering operation for the game entry of the target game, the game interface of the target game transmitted by the shared virtual machine is obtained, and the game interface is displayed. Since the game interface is rendered by the computing power resource provided by the shared virtual machine on the cloud gaming platform, and the computing power resource provided by the shared virtual machine is at least part of the computing power resource of a terminal on which the shared virtual machine is installed, the cloud gaming is implemented by means of the computing power resource and the storage resource provided by the virtual machine. This indirectly expands the computing power resource and the storage resource of the cloud gaming platform, reduces the situation that the game cannot be normally played due to limited computing power of the cloud gaming platform, improves the cloud gaming response efficiency, and improves the cloud gaming interaction efficiency.

In some aspects, as shown in FIG. 14, a cloud gaming interaction method is provided. The method may be performed by a terminal or a server, or may be performed jointly by the terminal and the server. A description is made by using an example in which the method is applied to a server in FIG. 1, the method includes the following operations:

Operation 1402: Determine a target shared virtual machine from shared virtual machines of a cloud gaming platform in response to a start request of a second terminal for a target game, the cloud gaming platform having a permission for scheduling at least part of a computing power resource of a terminal on which the shared virtual machine is installed, and the target shared virtual machine is currently in a shared state and has the target game installed thereon. In an example, a target shared virtual machine is determined from a plurality of shared virtual machines of a cloud gaming platform based on a start request of a second terminal for a target game. The target shared virtual machine is in a shared state and configured to access at least a part of a computing power resource of a first terminal of a plurality of terminals. The plurality of shared virtual machines are provided by the plurality of terminals.

Specifically, in response to the start request of the second terminal for the target game, the server searches for the shared virtual machine that is currently in the shared state and has the target game installed thereon from the shared virtual machines of the cloud gaming platform. In a case that the shared virtual machine is retrieved, the retrieved shared virtual machine, i.e., the target shared virtual machine is scheduled to the second terminal to trigger the target shared virtual machine, to start the target game, render a game interface of the target game, and transmit the rendered game interface to the second terminal. For example, the server schedules the target shared virtual machine as a server of the second terminal for rendering the game interface, triggers the establishment of a communication connection between the target shared virtual machine and the second terminal based on the access information of the target shared virtual machine, and transmits a start instruction for starting the target game to the second terminal. The second terminal starts the target game, renders the game interface of the target game in response to the start instruction, and transmits the rendered game interface to the second terminal.

Operation 1404: Trigger the establishment of the communication connection between the target shared virtual machine and the second terminal based on access information of the target shared virtual machine, the access information of the target shared virtual machine being configured for accessing the target shared virtual machine, where the communication connection is configured for transmitting an operation instruction triggered by the second terminal for the target game to the target shared virtual machine, and transmitting the game interface rendered by the target shared virtual machine according to the operation instruction to the second terminal. In an example, establishment of a communication connection between the target shared virtual machine of the first terminal and the second terminal is triggered based on access information of the target shared virtual machine. An operation instruction for the target game is transmitted by the second terminal to the target shared virtual machine via the communication connection. Game content is rendered by the target shared virtual machine according to the operation instruction and transmitted to the second terminal.

Specifically, the server stores a network address of the target shared virtual machine. The server may transmit the network address of the target shared virtual machine to the second terminal, whereby the second terminal may transmit a request for establishing the communication connection with the target shared virtual machine based on the network address, to establish the communication connection between the target shared virtual machine and the second terminal.

In some aspects, in a case that it is determined that the target shared virtual machine is in a logged-in state, the server triggers the establishment of the communication connection between the target shared virtual machine and the second terminal based on the network address of the target shared virtual machine. The server may store login information of the target shared virtual machine. In a case that it is determined that the target shared virtual machine is in a non-logged-in state, the server transmits a login request carrying the login information to the target shared virtual machine. The target shared virtual machine responds to the login request and performs login according to the login information. After the successful login, namely, the target shared virtual machine is in the logged-in state, the server triggers the establishment of the communication connection between the target shared virtual machine and the second terminal based on the network address of the target shared virtual machine.

In the foregoing cloud gaming interaction method, the target shared virtual machine is determined from the shared virtual machines of the cloud gaming platform in response to the start request of the second terminal for the target game, the cloud gaming platform has the permission for scheduling at least part of the computing power resource of the terminal on which the shared virtual machine is installed, and the target shared virtual machine refers to the shared virtual machine that is currently in the shared state and has the target game installed thereon. The establishment of the communication connection between the target shared virtual machine and the second terminal is triggered based on the access information of the target shared virtual machine, where the access information of the target shared virtual machine is configured for accessing the target shared virtual machine, and the communication connection is configured for transmitting the operation instruction triggered by the second terminal for the target game to the target shared virtual machine, and transmitting the game interface rendered by the target shared virtual machine according to the operation instruction to the second terminal. Therefore, the cloud gaming is implemented by means of the computing power resource and the storage resource provided by the virtual machine. This indirectly expands the computing power resource and storage resource of the cloud gaming platform, reduces the situation that the game cannot be normally played due to limited computing power of the cloud gaming platform, improves the cloud gaming response efficiency, and improves the cloud gaming interaction efficiency.

In some aspects, the operation of determining a target shared virtual machine from shared virtual machines of a cloud gaming platform in response to a start request of a second terminal for a target game includes: the computing power resource of the cloud gaming platform is evaluated in response to the start request of the second terminal for the target game; and the target shared virtual machine is determined from the shared virtual machines of the cloud gaming platform in a case that it is determined that the computing power resource of the cloud gaming platform is insufficient.

Specifically, the server evaluates the computing power resource of the cloud gaming platform in response to the start request of the second terminal for the target game, and determines the target shared virtual machine from the shared virtual machines of the cloud gaming platform in a case that it is determined that the computing power resource of the cloud gaming platform is insufficient. In a case that it is determined that the computing power resource of the cloud gaming platform is sufficient, the computing power resource of the cloud gaming platform is scheduled to provide a game rendering service for the second terminal.

In the present aspect, in a case that it is determined that computing power resource of the cloud gaming platform is insufficient, the target shared virtual machine is determined from the shared virtual machines of the cloud gaming platform, whereby the resource may still be rapidly scheduled for the second terminal in a case that the computing power resource of the cloud gaming platform is insufficient, enabling the cloud gaming to be performed normally, and improving the cloud gaming interaction efficiency.

In some aspects, login information of each shared virtual machine is shared with the cloud gaming platform after authorization; the operation of triggering establishment of a communication connection between the target shared virtual machine and the second terminal based on the access information of the target shared virtual machine includes: a login request is transmitted to the target shared virtual machine in a case that the target shared virtual machine is in a non-logged-in state, the login request carrying the login information of the target shared virtual machine, and the login information of the target shared virtual machine being configured for logging into the target shared virtual machine; and the establishment of the communication connection between the target shared virtual machine and the second terminal is triggered in a case that the target shared virtual machine is successfully logged in.

Specifically, the server determines the target shared virtual machine from the shared virtual machines of the cloud gaming platform in response to the start request of the second terminal for the target game, and transmits the login request to the target shared virtual machine in a case that the target shared virtual machine is in the non-logged-in state; and the login request carries the login information of the target shared virtual machine. The target shared virtual machine responds to the login request and performs login according to the login information. Upon determining successful login, namely, determining that the target shared virtual machine is in the logged-in state, the server may transmit the network address of the target shared virtual machine to the second terminal, whereby the second terminal may transmit a communication connection establishment request to the target shared virtual machine based on the network address, to establish the communication connection between the target shared virtual machine and the second terminal.

In the present aspect, the cloud gaming platform may log into the target shared virtual machine by means of the login information of the target shared virtual machine, whereby the target shared virtual machine may still be successfully scheduled to perform game rendering for the second terminal in a case that the target shared virtual machine is in the non-logged-in state, and consequently, the cloud gaming interaction efficiency is improved.

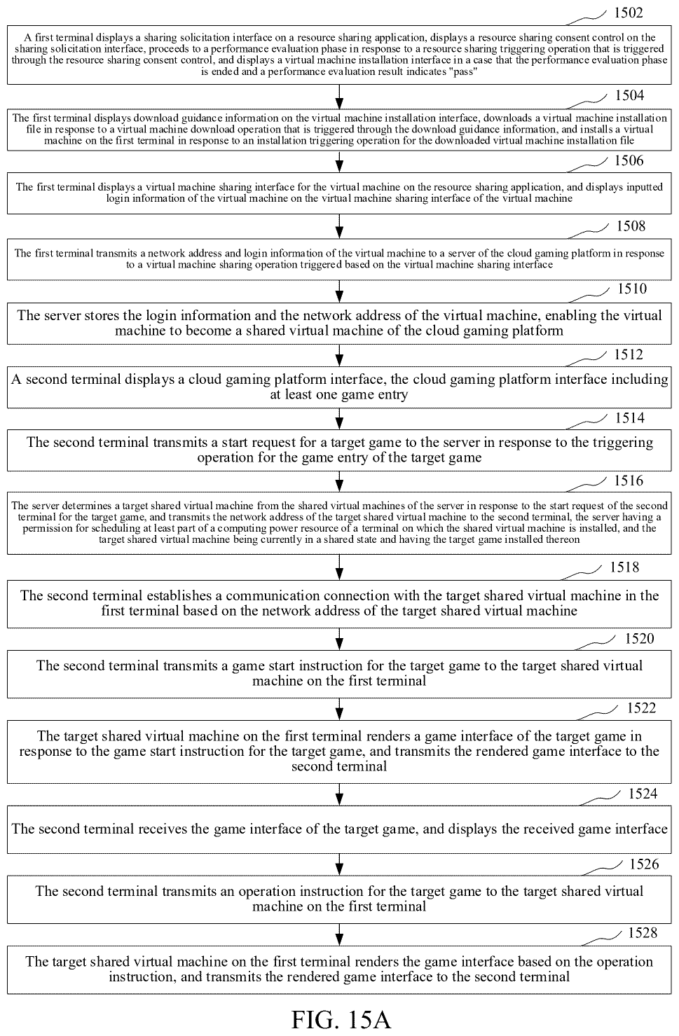

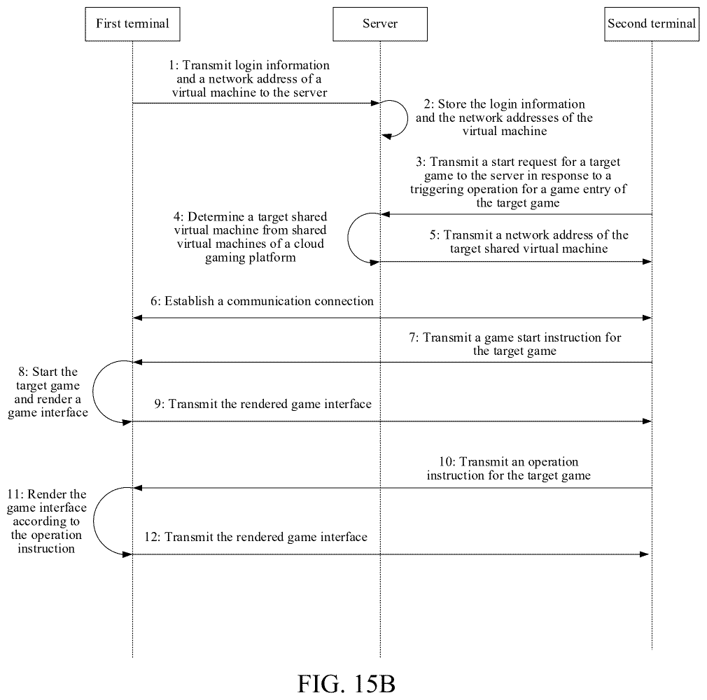

In some aspects, as shown in FIG. 15A, a cloud gaming interaction method is provided. The method may be performed by a terminal or may be performed jointly by the terminal and the server. A description is made by using an example in which the method is executed by a first terminal, a server, and a second terminal. The method includes the following operations:

Operation 1502: The first terminal displays a sharing solicitation interface on a resource sharing application, displays a resource sharing consent control on the sharing solicitation interface, proceeds to a performance evaluation phase in response to a resource sharing triggering operation triggered by the resource sharing consent control, and displays a virtual machine installation interface in a case that the performance evaluation phase is ended and a performance evaluation result indicates “pass”.

Operation 1504: The first terminal displays download guidance information on the virtual machine installation interface, downloads a virtual machine installation file in response to a virtual machine download operation triggered by means of the download guidance information, and installs a virtual machine on the first terminal in response to an installation triggering operation for the downloaded virtual machine installation file.

Operation 1506: The first terminal displays a virtual machine sharing interface for the virtual machine on the resource sharing application, and displays inputted login information of the virtual machine on the virtual machine sharing interface of the virtual machine.

Operation 1508: The first terminal transmits a network address and login information of the virtual machine to a server of the cloud gaming platform in response to a virtual machine sharing operation triggered based on the virtual machine sharing interface.

Operation 1510: The server stores the login information and the network address of the virtual machine, enabling the virtual machine to become a shared virtual machine of the cloud gaming platform.

Operation 1512: The second terminal displays a cloud gaming platform interface, the cloud gaming platform interface including at least one game entry.

Operation 1514: The second terminal transmits a start request for a target game to the server in response to a triggering operation for a game entry of the target game.

Operation 1516: The server determines a target shared virtual machine from the shared virtual machines of the server in response to the start request of the second terminal for the target game, and transmits the network address of the target shared virtual machine to the second terminal, a server having a permission for scheduling at least part of a computing power resource of a terminal on which the shared virtual machine is installed, and the target shared virtual machine being currently in a shared state and having the target game installed thereon.

The target shared virtual machine may be installed on the first terminal, or may be shared by another terminal with the cloud gaming platform. In the present aspect, an example in which the target shared virtual machine is installed on the first terminal is used.

Operation 1518: The second terminal establishes a communication connection with the target shared virtual machine on the first terminal based on the network address of the target shared virtual machine.

The communication connection is configured for transmitting an operation instruction triggered by the second terminal for the target game to the target shared virtual machine, and transmitting the game interface rendered by the target shared virtual machine according to the operation instruction to the second terminal.

Operation 1520: The second terminal transmits a game start instruction for the target game to the target shared virtual machine on the first terminal.

Operation 1522: The target shared virtual machine on the first terminal renders a game interface of the target game in response to the game start instruction for the target game, and transmits the rendered game interface to the second terminal.

Operation 1524: The second terminal receives the game interface of the target game, and displays the received game interface.

Operation 1526: The second terminal transmits an operation instruction for the target game to the target shared virtual machine on the first terminal.

Operation 1528: The target shared virtual machine on the first terminal renders the game interface based on the operation instruction, and transmits the rendered game interface to the second terminal.

FIG. 15B is a sequence diagram illustrating interaction among a first terminal, a second terminal, and a server according to some aspects. The interaction sequence diagram includes the following operations:

1: Transmit login information and a network address of a virtual machine to the server.

The first terminal transmits the login information and the network address of the virtual machine to the server.

2: Store the login information and the network addresses of the virtual machine.

The server stores the login information and the network address of the virtual machine.

3: Transmit a start request for a target game to the server in response to a triggering operation for a game entry of the target game.

The second terminal transmits the start request for the target game to the server in response to the triggering operation for the game entry of the target game.

4: Determine a target shared virtual machine from shared virtual machines of a cloud gaming platform

The server determines the target shared virtual machine from the shared virtual machines of the cloud gaming platform in response to the start request for the target game.

5: Transmit the network address of the target shared virtual machine.

The server transmits the network address of the target shared virtual machine to the second terminal.

6: Establish a communication connection.

The communication connection is established between the first terminal and the second terminal.

7: Transmit a game start instruction for the target game.

The second terminal transmits the game start instruction for the target game to the first terminal.

8: Start the target game and render a game interface.

The first terminal starts the target game in response to the game start instruction and renders the game interface.

9: Transmit the rendered game interface.

The first terminal transmits the rendered game interface to the second terminal.

10: Transmit an operation instruction for the target game.

The second terminal transmits the operation instruction for the target game to the first terminal.

11: Render the game interface according to the operation instruction.

The first terminal renders the game interface according to the operation instruction.

12: Transmit the rendered game interface.

The first terminal transmits the rendered game interface to the second terminal.

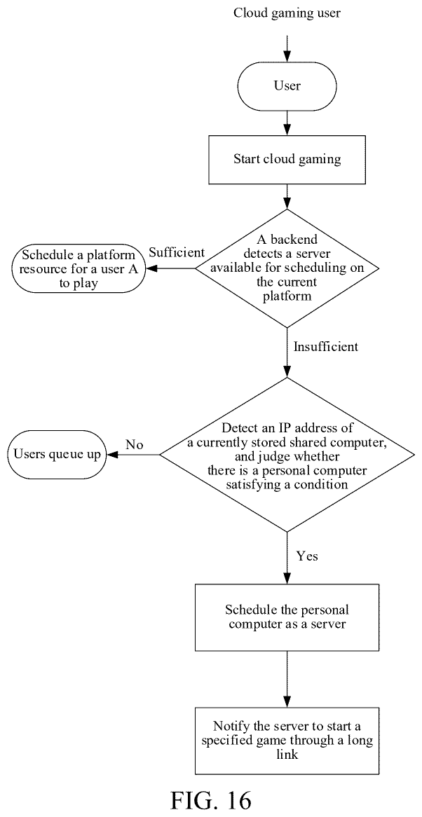

For example, as shown in FIG. 16, a user starts a helper program of cloud gaming on a personal computer. The helper program generates a pop-up window inquiring whether the user needs to proceed with sharing. If the user selects “No”, the process is terminated directly; if “Yes” is selected, a subsequent operation is performed. The helper program starts a performance detection program, to separately detect whether performance of devices related to storage space, the video card, the graphics processing unit (GPU), and the central processing unit (CPU) of a user computer reaches a standard of a cloud gaming backend. If the performance fails to reach the standard, the procedure is directly terminated, and the user is notified. If the performance reaches the standard, the pop-up window guides the user to download a virtual machine and install the virtual machine. Because space between the virtual machine and a host computer is isolated, a cloud gaming server backend performs an operation only on the virtual machine without affecting personal data in the space of the host computer of the user. After the user downloads and installs the virtual machine, the user is prompted to set up an account and a password that are then transmitted to the cloud gaming backend via the cloud gaming helper program. The backend records the account and the password corresponding to an IP address and stores the account and the password into a database to provide query records for subsequent scheduling. The cloud gaming backend notifies the virtual machine through a socket, and downloads a related game client.

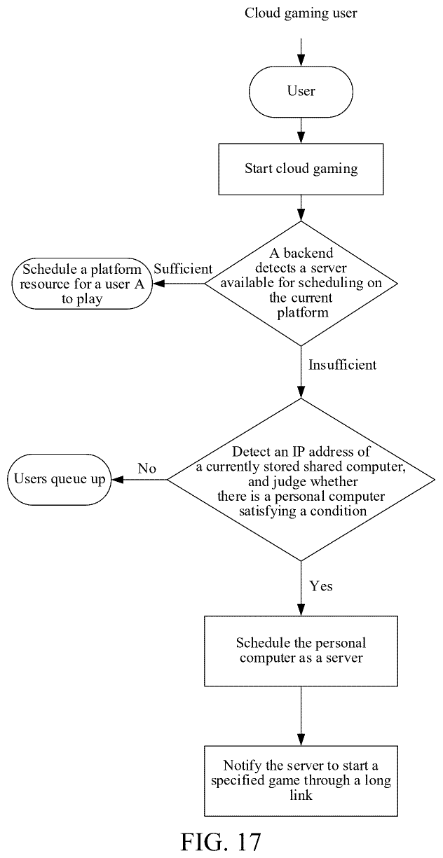

As shown in FIG. 17, a terminal of a cloud gaming user starts the cloud gaming. The cloud gaming backend detects whether the resource of the current server is sufficient, and if the resource of the server is sufficient, the resource of the platform is directly scheduled for the user to play smoothly. If all servers of the current platform are in an operating state, the database is queried to determine whether any server resource shared from a personal computer exists. If no server resource is shared from the personal computer, the user attempting to access the cloud gaming is notified that the resource is currently insufficient and queuing is required, and a queuing button is displayed at the client. If there is a shared personal computer, namely there is the shared virtual machine, and a related game is already downloaded, the personal computer is scheduled to serve as a server. To be specific, the corresponding virtual machine in the personal computer is scheduled to serve as the server; and meanwhile, the personal computer is notified to start the game through the socket. After receiving an instruction, the personal computer starts a specified game, encodes a rendered picture of the game, and transmits the rendered picture to the terminal of the cloud gaming user over a network. The rendered picture is decoded by a cloud gaming client on the terminal of the cloud gaming user, and then displayed, thus completing an entire scheduling process. The cloud gaming backend records a playtime duration of the cloud gaming user, and adopts the playtime duration as a standard for subsequently issuing the duration to a user sharing the personal computer. When there is a large number of cloud gaming users, the cloud gaming platform may experience resource shortage, and the users are encouraged to share the personal computers as the platform resources, whereby on one hand, a problem that the users need to queue up due to insufficient cloud gaming backend resources can be solved, and on the other hand, the resources that can be shared by the users can be fully used. The users sharing the resources can be rewarded correspondingly, whereby a double-win effect between the platform and the users can be achieved; and moreover, the number of users and a commercial system of the cloud gaming are greatly improved.

In the present aspect, the cloud gaming is implemented by means of the computing power resource and the storage resource provided by the virtual machine. This indirectly expands the computing power resource and the storage resource of the cloud gaming platform, reduces the situation that the game cannot be normally played due to limited computing power of the cloud gaming platform, improves the cloud gaming response efficiency, and improves the cloud gaming interaction efficiency.

Although the operations are displayed sequentially according to instructions of arrows in the flowcharts involved in various foregoing aspects, these operations are not necessarily performed sequentially according to the sequence instructed by the arrows. Unless otherwise explicitly specified in this disclosure, execution of the steps is not strictly limited, and the steps may be performed in other sequences. Moreover, at least some of the operations in the flowcharts involved in various foregoing aspects may include a plurality of operations or a plurality of stages. The operations or stages are not necessarily performed at the same moment but may be performed at different moments. The operations or stages are not necessarily sequentially performed, but may be performed alternately with other operations or at least some operations or stages of other operations.

Based on a similar concept, an aspect of this disclosure further provides a cloud gaming interaction apparatus configured to implement the foregoing cloud gaming interaction method. An implementation solution to the problem provided by the apparatus is similar to an implementation solution stated in the foregoing method. Therefore, for examples of specific processes to be performed by one or more cloud gaming interaction apparatus aspects provided below, reference can be made to the examples of the foregoing cloud gaming interaction method. Details are not described herein again.

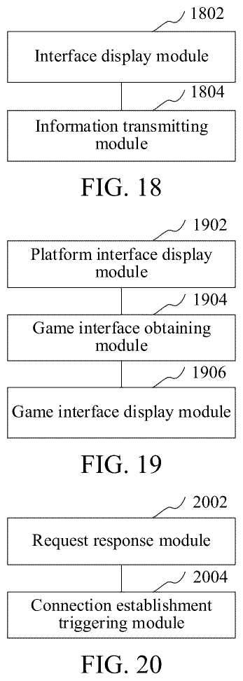

In some aspects, as shown in FIG. 18, a cloud gaming interaction apparatus is provided, which includes: an interface display module 1802 and an information transmitting module 1804, where the interface display module 1802 is configured to display a virtual machine sharing interface for a virtual machine installed on a first terminal in response to a resource sharing triggering operation initiated at the first terminal; and the installed virtual machine occupies at least part of a computing power resource in the first terminal.

The information transmitting module 1804 is configured to transmit access information of the virtual machine to a cloud gaming platform in response to the virtual machine sharing operation triggered based on the virtual machine sharing interface, to cause the cloud gaming platform to obtain a permission for scheduling the computing power resource, occupied by the virtual machine, of the first terminal according to the access information; and the access information is configured for accessing the virtual machine.

In some aspects, the interface display module 1802 is further configured to display a virtual machine installation interface in response to the resource sharing triggering operation that is initiated at the first terminal; and install the virtual machine on the first terminal in response to triggering for the virtual machine installation interface.

In some aspects, the interface display module 1802 is further configured to proceed to a performance evaluation phase in response to the resource sharing triggering operation that is initiated at the first terminal, the performance evaluation phase being configured for evaluating whether the first terminal satisfies a computing power resource sharing condition; and display the virtual machine installation interface in a case that the performance evaluation phase is ended and a performance evaluation result indicates “pass”.

In some aspects, the apparatus is further configured to display download guidance information on the virtual machine installation interface: the interface display module 1802 is further configured to: download a virtual machine installation file in response to a virtual machine download operation triggered through the download guidance information; and install the virtual machine on the first terminal in response to an installation triggering operation for the downloaded virtual machine installation file.

In some aspects, the interface display module 1802 is further configured to display a resource sharing consent control on a sharing solicitation interface, the sharing solicitation interface being configured to solicit a consent of sharing the computing power resource of the first terminal with the cloud gaming platform; and proceed to the performance evaluation phase in response to the resource sharing triggering operation that is triggered through the resource sharing consent control.

In some aspects, the access information includes login information of the virtual machine; the information transmitting module 1808 is further configured to display inputted login information of the virtual machine on the virtual machine sharing interface of the virtual machine; and transmit the login information of the virtual machine to the cloud gaming platform in response to the virtual machine sharing operation triggered based on the virtual machine sharing interface.

In some aspects, the apparatus is further configured to receive a game installation instruction transmitted by the cloud gaming platform to the virtual machine, the game installation instruction being configured for triggering installation of a specified game in the virtual machine; and install the specified game in the virtual machine in response to the game installation instruction.

In some aspects, the access information includes a network address of the virtual machine; the apparatus is further configured to receive a game rendering instruction, transmitted by a second terminal, for the specified game installed in the virtual machine in a case that the virtual machine is in a logged-in state, the game rendering instruction being transmitted by the second terminal to the first terminal based on the network address of the virtual machine, and the network address, used by the second terminal, of the virtual machine being transmitted by the cloud gaming platform to the second terminal; and render a game interface of the specified game according to the game rendering instruction, and return rendered game interface to the second terminal.

In some aspects, after the first terminal shares the computing power resource with the second terminal, a cloud gaming account obtains an acceleration virtual resource, and the acceleration virtual resource is configured for accelerating a queuing progress of the cloud gaming account when the cloud gaming account needs to queue up to enter a game on the cloud gaming platform; and the cloud gaming account is configured for logging into the cloud gaming platform at the first terminal.

In some aspects, the cloud gaming platform stores the login information of the virtual machine; the apparatus is further configured to receive a login request transmitted by the cloud gaming platform for the virtual machine in a case that the virtual machine is in a non-logged-in state, the login request carrying the login information of the virtual machine; and log into the virtual machine based on the login information, carried in the login request, of the virtual machine.

In some aspects, the interface display module 1802 is further configured to display an interface of a resource sharing application, the resource sharing application being configured to provide a service of sharing the computing power resource of a terminal with the cloud gaming platform; and display the virtual machine installation interface on the resource sharing application in response to the resource sharing triggering operation that is triggered through the interface of the resource sharing application and that is initiated at the first terminal.

In some aspects, the interface display module 1802 is further configured to display a login interface of the resource sharing application; display a cloud gaming account inputted into the login interface, the cloud gaming account being configured for logging into the cloud gaming platform; and display the interface of the resource sharing application in a case that the cloud gaming account successfully logs into the resource sharing application; and the information transmitting module 1808 is further configured to transmit the access information of the virtual machine and the cloud gaming account that currently logs into the resource sharing application in response to the virtual machine sharing operation triggered based on the virtual machine sharing interface to the cloud gaming platform.

In some aspects, as shown in FIG. 19, a cloud gaming interaction apparatus is provided, which includes: a platform interface display module 1902, a game interface obtaining module 1904, and a game interface display module 1906, where the platform interface display module 1902 is configured to display a cloud gaming platform interface; and the cloud gaming platform interface includes at least one game entry.

The game interface obtaining module 1904 is configured to obtain a game interface of a target game transmitted by a shared virtual machine in response to a triggering operation for the game entry of the target game; the game interface is rendered by a computing power resource provided by the shared virtual machine on the cloud gaming platform; and the computing power resource provided by the shared virtual machine is at least part of a computing power resource of a terminal on which the shared virtual machine is installed.

The game interface display module 1906 is configured to display the game interface.

In some aspects, as shown in FIG. 20, a cloud gaming interaction apparatus is provided, which includes: a request response module 2002 and a connection establishment triggering module 2004, where the request response module 2002 is configured to determine a target shared virtual machine from shared virtual machines of a cloud gaming platform in response to a start request of a second terminal for a target game; the cloud gaming platform has a permission for scheduling at least part of a computing power resource of the terminal on which the shared virtual machine is installed; and the target shared virtual machine is currently in a shared state and has the target game installed thereon.

The connection establishment triggering module 2004 is configured to trigger establishment of a communication connection between the target shared virtual machine and the second terminal based on access information of the target shared virtual machine; and the communication connection is configured for transmitting an operation instruction triggered by the second terminal for the target game to the target shared virtual machine, and transmitting a game interface rendered by the target shared virtual machine according to the operation instruction to the second terminal.

In some aspects, the request response module 2002 is further configured to evaluate the computing power resource of the cloud gaming platform in response to a start request of the second terminal for the target game; and determine the target shared virtual machine from shared virtual machines of the cloud gaming platform in a case that it is determined that the computing power resource of the cloud gaming platform is insufficient.

In some aspects, login information of each shared virtual machine is shared with the cloud gaming platform after authorization; the connection establishment triggering module 2004 is further configured to transmit a login request to the target shared virtual machine in a case that the target shared virtual machine is in a non-logged-in state, the login request carrying the login information of the target shared virtual machine, and the login information of the target shared virtual machine being configured for logging into the target shared virtual machine; and trigger the establishment of the communication connection between the target shared virtual machine and the second terminal in a case that the target shared virtual machine is successfully logged in.

All or some of modules in the foregoing cloud gaming interaction apparatus may be implemented by using software, hardware, or a combination thereof. The foregoing modules may be embedded to or may be independent from processing circuitry, such as a processor in a computer device in a hardware form, or may be stored in a memory in the computer device in a software form, to facilitate the processor to execute the operations corresponding to each module.

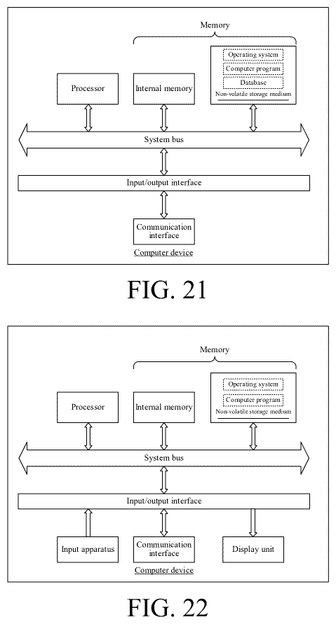

In some aspects, a computer device is provided. The computer device may be a server, and an internal structure diagram thereof may be shown in FIG. 21. The computer device includes a processor, a memory, an input/output interface (briefly referred to as I/O), and a communication interface. The processor, the memory, and the input/output interface are connected to each other by using a system bus, and the communication interface is connected to the system bus by using the input/output interface. The processor of the computer device is configured to provide computation and control capabilities. The memory of the computer device includes a non-volatile storage medium, such as a non-transitory computer-readable storage medium, and an internal memory. The non-volatile storage medium stores an operating system, computer programs, and databases. The internal memory provides an operating environment for the operating system and the computer programs in the non-volatile storage medium. The database of the computer device is configured to store data involved in the foregoing cloud gaming interaction method. The input/output interface of the computer device is configured to exchange information between the processor and peripheral equipment. The communication interface of the computer device is configured to connect and communicate with an external terminal through a network. The computer programs, when executed by the processor, implement the cloud gaming interaction method.

In some aspects, a computer device is provided. The computer device may be a terminal, and an internal structure diagram thereof may be as shown in FIG. 22. The computer device includes a processor, a memory, an input/output interface, a communication interface, a display unit, and an input apparatus. The processor, the memory, and the input/output interface are connected by a system bus, and the communication interface, the display unit, and the input apparatus are connected to the system bus through the input/output interface. The processor of the computer device is configured to provide computation and control capabilities. The memory of the computer device includes a non-volatile storage medium and an internal memory. The non-volatile storage medium stores an operating system and computer programs. The internal memory provides an operating environment for the operating system and the computer programs in the non-volatile storage medium. The input/output interface of the computer device is configured to exchange information between the processor and peripheral equipment. The communication interface of the computer device is configured to communicate with external terminals in a wired way or a wireless way, and the wireless way may be implemented by WiFi, mobile cellular networks, near-field communication (NFC) or other technologies. The computer programs, when executed by the processor, implement the cloud gaming interaction method. The display unit of the computer device may be configured to form a visually visible screen and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, a mouse or the like.

A person skilled in the art may understand that, structures shown in FIG. 21 and FIG. 22 are merely block diagrams of a partial structure related to a solution in this disclosure, and do not constitute a limitation to the computer device to which the solution in the disclosure is applied. Specifically, the computer device may include more components or fewer components than those shown in the figure, or some components may be combined, or a different component deployment may be used.

In some aspects, a computer device is provided, including a memory and a processor, the memory having a computer program stored therein, the computer program, when executed by the processor, implementing the operations of the foregoing cloud gaming interaction method.

In some aspects, a computer-readable storage medium, such as a non-transitory computer-readable storage medium, is provided, having a computer program stored therein. The computer program, when executed by a processor, implements the operations of the foregoing cloud gaming interaction method.

In some aspects, a computer program product is provided, including a computer program. The computer program, when executed by a processor, implements the operations of the foregoing cloud gaming interaction method.

A person of ordinary skill in the art may understand that all or some of procedures of the method in the foregoing aspects may be implemented by a computer program instructing relevant hardware. The program may be stored in a non-volatile computer-readable storage medium. When the program is executed, the procedures of the foregoing method aspects may be implemented. Any reference to a memory, a database, or another medium used in the aspects provided in this disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magneto-resistive random access memory (MRAM), a ferroelectric random access memory (FRAM), a phase change memory (PCM), a graphene memory, or the like. The volatile memory may include a random access memory (RAM) and an external cache. As illustration rather than limitation, the RAM may be in various forms, such as a static random access memory (SRAM), or a dynamic random access memory (DRAM). The database involved in the aspects provided in this disclosure may include at least one of a relational database and a non-relational database. The non-relational database may include a block-chain-based distributed database, or the like, but is not limited thereto. Processing circuitry, such as the processor involved in the aspects provided in this disclosure, may include a general-purpose processor, a central processing unit, a graphics processing unit, a digital signal processor, a programmable logic device, a quantum computing-based data processing logic device, or the like, but is not limited thereto.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

Technical features of the foregoing aspects may be combined in different manners. To make description concise, not all possible combinations of the technical features in the foregoing aspects are described. However, the combinations of these technical features shall be considered as falling within the scope recorded by this specification provided that no conflict exists.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing aspects only describe several implementations of this disclosure which are not to be construed as a limitation to the scope of this disclosure. For a person of ordinary skill in the art, several transformations and improvements can be made without departing from the idea of this disclosure. These transformations and improvements belong to the protection scope of this disclosure.

What is claimed is:

1. A cloud gaming processing method, comprising:
displaying a virtual machine sharing interface of a virtual machine installed on a first terminal based on a resource sharing triggering operation, the virtual machine being configured to access at least part of a computing power resource in the first terminal; and
transmitting access information of the virtual machine to a cloud gaming platform based on a virtual machine sharing operation, the virtual machine sharing operation being performed via the virtual machine sharing interface, wherein
the cloud gaming platform schedules access to the computing power resource via the virtual machine of the first terminal based on the access information.

2. The method according to claim 1, wherein the displaying the virtual machine sharing interface comprises:
displaying a virtual machine installation interface based on the resource sharing triggering operation being performed at the first terminal; and
installing the virtual machine on the first terminal based on an installation triggering operation being performed via the virtual machine installation interface.

3. The method according to claim 2, wherein the displaying the virtual machine installation interface comprises:
based on the resource sharing triggering operation being performed at the first terminal, evaluating whether the first terminal satisfies a computing power resource sharing condition; and
displaying the virtual machine installation interface based on the computing power resource sharing condition being satisfied.

4. The method according to claim 3, wherein the evaluating comprises:
displaying a resource sharing consent control element on a sharing solicitation interface, the sharing solicitation interface being configured to solicit consent for sharing the computing power resource of the first terminal with the cloud gaming platform; and
evaluating whether the first terminal satisfies the computing power resource sharing condition based on the resource sharing triggering operation being performed via a user selection of the resource sharing consent control element.

5. The method according to claim 2, further comprising:
displaying download guidance information on the virtual machine installation interface,
wherein the installing the virtual machine comprises:
downloading a virtual machine installation file based on a virtual machine download operation being performed via the download guidance information; and
installing the virtual machine on the first terminal based on the downloaded virtual machine installation file.

6. The method according to claim 1, wherein
the access information includes login information of the virtual machine; and
the transmitting the access information includes transmitting the login information of the virtual machine to the cloud gaming platform based on the virtual machine sharing operation being performed via the virtual machine sharing interface.

7. The method according to claim 1, further comprising:
receiving a game installation instruction transmitted by the cloud gaming platform to the virtual machine; and
installing a specified game in the virtual machine based on the game installation instruction.

8. The method according to claim 1, wherein
the access information includes a network address of the virtual machine; and
the method further comprises:
receiving a game rendering instruction transmitted by a second terminal for a specified game installed in the virtual machine, the game rendering instruction being transmitted by the second terminal to the first terminal based on the network address of the virtual machine, the network address being transmitted by the cloud gaming platform to the second terminal;
rendering game content of the specified game according to the game rendering instruction; and
returning the rendered game content to the second terminal.

9. The method according to claim 1, wherein
a cloud gaming account is associated with an acceleration virtual resource that is accumulated based on usage of the computing power resource in the first terminal, and
acceleration of a queuing progress of the cloud gaming account by the cloud gaming platform is based on the acceleration virtual resource.

10. The method according to claim 6, wherein
the access information includes the login information of the virtual machine; and
the method further comprises:
receiving a login request transmitted by the cloud gaming platform for the virtual machine based on the virtual machine being in a non-logged-in state, the login request including the login information of the virtual machine; and
logging the cloud gaming platform into the virtual machine based on the login information carried in the login request of the virtual machine.

11. The method according to claim 2, wherein the displaying the virtual machine installation interface comprises:
displaying an interface of a resource sharing application, the resource sharing application being configured to provide a service of sharing the computing power resource of the first terminal with the cloud gaming platform; and
displaying the virtual machine installation interface on the resource sharing application based on the resource sharing triggering operation being performed via the interface of the resource sharing application.

12. The method according to claim 11, wherein
the displaying the interface of the resource sharing application comprises:
displaying a login interface of the resource sharing application; and
displaying the interface of the resource sharing application based on the resource sharing application being successfully logged in based on a cloud gaming account via the login interface; and
the transmitting the access information includes transmitting the access information of the virtual machine and the cloud gaming account to the cloud gaming platform based on the virtual machine sharing operation being performed via the virtual machine sharing interface.

13. A cloud gaming processing method, comprising:
determining a target shared virtual machine from a plurality of shared virtual machines of a cloud gaming platform based on a start request of a second terminal for a target game, the target shared virtual machine being in a shared state and configured to access at least a part of a computing power resource of a first terminal of a plurality of terminals, and the plurality of shared virtual machines being provided by the plurality of terminals; and
triggering establishment of a communication connection between the target shared virtual machine of the first terminal and the second terminal based on access information of the target shared virtual machine, wherein
an operation instruction for the target game is transmitted by the second terminal to the target shared virtual machine via the communication connection; and
game content is rendered by the target shared virtual machine according to the operation instruction and transmitted to the second terminal.

14. The method according to claim 13, wherein the determining the target shared virtual machine comprises:
evaluating an available computing power resource of the cloud gaming platform based on the start request of the second terminal for the target game; and
determining the target shared virtual machine from the plurality of shared virtual machines of the cloud gaming platform based on the available computing power resource of the cloud gaming platform.

15. The method according to claim 13, wherein the triggering the establishment of the communication connection comprises:
transmitting a login request to the target shared virtual machine, the login request including login information of the target shared virtual machine; and
triggering the establishment of the communication connection between the target shared virtual machine and the second terminal based on the cloud gaming platform being logged into the target shared virtual machine.

16. The method according to claim 13, wherein
a cloud gaming account is associated with an acceleration virtual resource that is accumulated based on usage of the computing power resource in the first terminal, and
acceleration of a queuing progress of the cloud gaming account by the cloud gaming platform is based on the acceleration virtual resource.

17. A cloud gaming processing system, comprising:
a first terminal including processing circuitry that is configured to:
display a virtual machine sharing interface of a virtual machine installed on the first terminal based on a resource sharing triggering operation, the virtual machine being configured to access at least part of a computing power resource in the first terminal; and
transmit access information of the virtual machine to a cloud gaming platform based on a virtual machine sharing operation, the virtual machine sharing operation being performed via the virtual machine sharing interface, wherein
the cloud gaming platform schedules access to the computing power resource via the virtual machine of the first terminal based on the access information.

18. The system according to claim 17, wherein the processing circuitry is configured to:
display a virtual machine installation interface based on the resource sharing triggering operation being performed at the first terminal; and
install the virtual machine on the first terminal based on an installation triggering operation being performed via the virtual machine installation interface.

19. The system according to claim 18, wherein the processing circuitry is configured to:
based on the resource sharing triggering operation being performed at the first terminal, evaluate whether the first terminal satisfies a computing power resource sharing condition; and
display the virtual machine installation interface based on the computing power resource sharing condition being satisfied.

20. The system according to claim 17, wherein
the access information includes a network address of the virtual machine; and
the processing circuitry is configured to:
receive a game rendering instruction transmitted by a second terminal for a specified game installed in the virtual machine, the game rendering instruction being transmitted by the second terminal to the first terminal based on the network address of the virtual machine, the network address being transmitted by the cloud gaming platform to the second terminal;
render game content of the specified game according to the game rendering instruction; and
return the rendered game content to the second terminal.
